(19) United States
(12) Patent Application Publication
(10) Pub. No.: US 2008/0294978 A1
(43) Pub. Date: Nov. 27, 2008

(54) SEMANTIC NAVIGATION THROUGH WEB CONTENT AND COLLECTIONS OF DOCUMENTS

(75) Inventors: Victor Klintsov, Port (CH); Vladimir Khoroshevskiy, Moscow (RU)

Correspondence Address: MYERS WOLIN, LLC, 100 HEADQUARTERS PLAZA, North Tower, 6th Floor, MORRISTOWN, NJ, 07960-6834, US

(73) Assignee: ONTOS AG, Nidau (CH)

(21) Appl. No.: 12/124,248

(22) Filed: May 21, 2008

Related U.S. Application Data
(63) Continuation of application No. PCT/EP2007/054900, filed on May 21, 2007.

(51) Int. Cl. G06F 17/21; G06F 17/30

(52) U.S. Cl. 715/234

(57) ABSTRACT

The present invention provides method and apparatus, including computer program products, A method for marking-up a plurality of electronic documents, comprising: semantic marking-up electronic documents according to a predetermined domain model presented in the form of domain ontology, thereby creating mark-up results represented in Ontology Web Language, OWL, format; and storing the mark-up results and the links to the marked-up electronic documents represented by Universal Resource Locators, URLs, in a Resource Description Framework, RDF, storage.

### CROSS-REFERENCE TO RELATED APPLICATIONS

This is a continuation application under 35 U.S.C. §111(a) of International Patent Application No. PCT/EP2007/054900 filed May 21, 2007, the contents of which are expressly incorporated herein by reference in its entirety.

### BACKGROUND OF THE INVENTION

1. Field of the Invention

The present invention relates to semantic navigating the documents sets, and more specifically, to a method and apparatus, including computer program products, for semantic navigation through Web content and documents collections based on results received within information extraction unit from (web) documents of interest of a user.

2. Description of the Related Art

Amount of computer available documents grows so dramatically that users have mass of the problems during navigation in global (World Wide Web) and local (corporative Data Warehouse) information spaces for locating and processing only documents relevant to their current needs.

There are several known techniques in use nowadays to help a user in orientation within a set of documents, in particular, search engines, site maps and links pages, catalogues and indexes, etc. In depth, all of them are based on “hyperlinks” incorporated into documents and special tools using these “hyperlinks” to support appropriate navigation.

All above-mentioned techniques are based on the usage of the well known Web browsers (for example, Microsoft Internet Explorer, Mozilla, Opera, etc.) to support user's navigation activity. And all such browsers at the deep level use, as a rule, HTML or XML based markup of the pages navigated that was incorporated into the pages by their authors and/or by web pages developers. So, in fact, the user can navigate via annotated by hyperlinks pages only within the predefined ways that can be inconvenient to his (her) current needs. Such navigation is time and labor consuming and in many cases does not provide useful results.

For the above mentioned reasons, it would be desirable to have intelligent tools for navigation through documents collections, such as the Web and/or corporative Knowledge Warehouses, which allow a user to freely fix within the documents being surfed only those ones, that are related to semantically significant, according to the current user's needs, objects and relations between them presented in the observed documents without relaying on predefined hyperlinks. Such tools should also provide a more convenient technique for intelligent navigation than existing navigation tools provided by Web browsers. In order to provide navigation through Web pages, the U.S. Pat. No. 6,862,710 B1, Mar. 1, 2005, “Internet Navigation Using Soft Hyperlinks” disclosed a method for Internet navigation based on the usage of “soft” hyperlinks which are created “on fly” by disclosed system employing a search engine in the background to retrieve a list of related terms and presenting the first four terms returned by search engine in special compass-like navigation card, and allowing the user to move from the current document to one of a number of document lists relevant to user's need.

Meanwhile, in order to support a navigation process, the U.S. Pat. Publication No. US 2006/0282409 A1, Dec. 14, 2006, “Automated World Wide Web Navigation and Content Extraction” disclosed a method for content extraction and conversion of the results into special logical model that can be used for automated generation of hyperlinks between fixed fragments of one page and/or between different pages without user intervention.

On the other hand, in order to provide a topic oriented Internet navigation, the U.S. Pat. Publication No. US 2006/0129549 A1, Jun. 15, 2006, “Topic-Focused Web Navigation” disclosed methods and apparatus, including computer program products, for topic-focused web navigation that is supported by browser plug-in that has possibilities to retrieve hit list received, for example, from search engine and to store them to a local database with their ranking, to ensure that the links, which refer to a hit in the lists, in a displayed page are highlighted with a color according to the topic and their ranking, to focus navigation only on those pages that are relevant for a user, etc.

These applications related to Web navigation, while they may be useful in navigation improvement, they do it without understanding the sense of the acquired terms, topics, etc. Thus, a need exists for a new method and apparatus for semantic navigation through documents collections, such as the Web and/or corporative Knowledge Warehouses based on knowledge driven information extraction and the usage of its results to support intelligent navigation.

### SUMMARY OF THE INVENTION

Additional aspects and/or advantages of the invention will be set forth in the claims as well as in part in the description which follows and, in part, will be apparent from the description, or may be learned by practice of the invention.

The present invention provides a method for semantic navigation through Web content and documents collections based on semantic markup of (web) documents.

The present invention provides a method for semantic navigation through Web content and documents collections based on results received within information extraction unit from (web) documents.

The present invention also provides an apparatus, including computer program products, for semantic navigation through Web content and documents collections based on semantic markup of (web) documents.

The present invention also provides an apparatus, including computer program products, for semantic navigation through Web content and documents collections based on results received within information extraction unit from (web) documents.

According to an aspect of the present invention, there is provided a method for semantic navigation through Web content and documents collections based on semantic markup of (web) documents including: manual markup of (web) documents with named entities (NE) and semantic relations (SR) between them with any external unit, and save markup results in OWL representation to RDF storage with merging new NEs and SRs with the already presented in RDF storage, and visualization of marked up (web) documents with NEs highlighted by different colors according their types, and navigation through (web) documents with highlighted NEs via navigation cards.

According to an aspect of the present invention, there is provided a method for semantic navigation through Web content and documents collections based on semantic markup of (web) documents including: automatic markup of (web) documents with named entities (NE) and semantic relations (SR) between them extracting from presented in natural language documents according to the method fixed in Russian Patent No 2242048, filed on Feb. 18, 2003, in the Russian Federal Service for Intellectual Property, Patents and Trademarks (ROSPATENT), and save markup results in OWL representation to RDF storage with merging new NEs and SRs with already presented in RDF storage, and visualization of marked up (web) documents with NEs highlighted by different colors according their types, and navigation through (web) documents with highlighted NEs via navigation cards.

According to another aspect of the present invention, there is provided a method for semantic digesting of already navigated documents based on navigation path (which reflects user's query for digesting) stored in navigation card and semantic markup of these documents stored in RDF storage.

According to still another aspect of the present invention, there is provided a method for semantic summarization based on the information extracted from related texts about object stored in RDF storage.

According to still another aspect of the present invention, there is provided an apparatus, including computer program products, for semantic navigation through Web content and documents collections based on semantic markup of (web) documents including: manual markup of (web) documents with Named Entities (NE) and semantic relations (SR) between them with any external unit, and save markup results in OWL representation to RDF storage with merging new NEs and SRs with already presented in RDF storage, and visualization of marked up (web) documents with NEs highlighted by different colors according their types, and navigation through (web) documents with highlighted NEs via navigation cards.

According to still another aspect of the present invention, there is provided an apparatus, including computer program products, for semantic navigation through Web content and documents collections based on semantic markup of (web) documents including: automatic markup of (web) documents with named entities (NE) and semantic relations (SR) between them extracting from presented in natural language documents according to the method fixed in Russian Patent No 2242048, filed on Feb. 18, 2003, in the Russian Federal Service for Intellectual Property, Patents and Trademarks (ROSPATENT), and save markup results in OWL representation to RDF(S) storage with merging new NEs and SRs with already presented in RDF(S) storage, and visualization of marked up (web) documents with NEs highlighted by different colors according their types, and navigation through (web) documents with highlighted NEs via navigation cards.

According to still another aspect of the present invention, there is provided an apparatus, including computer program products, for semantic digesting of already navigated documents based on navigation path (which reflects user's query for digesting) stored in navigation card and semantic markup of these documents stored in RDF storage.

According to still another aspect of the present invention, there is provided an apparatus, including computer program products, for semantic summarization based on the information extracted from related texts about object stored in RDF storage.

### Further Information About Technical Background to this Application

The disclosure of Russian Patent No 2242048, filed on Feb. 18, 2003, in the Russian Federal Service for Intellectual Property, Patents and Trademarks (ROSPATENT), including specification, drawings and claims is incorporated herein by reference in its entirety.

### BRIEF DESCRIPTION OF THE DRAWINGS

These and or other aspects and advantages of the invention will become apparent and more readily appreciated from the following description of the embodiments, taken in conjunction with the accompanying drawings of which:

FIG. 1 depicts a general architecture of the system for semantic navigation through Web content and documents collections according to an embodiment of the present invention;

FIG. 2a, 2b illustrate semantic markup of the Web page within server system shown in FIG. 1;

FIGS. 2a-1, 2a-2, 2b-1 and 2b-2 are enlargements of FIGS. 2a and 2b;

FIG. 3a, 3b present a fragment of relational table for semantic markup Web page shown in FIG. 2;

FIG. 4 is a fragment of domain ontology used by Information Extraction Unit to control text mining;

FIG. 5 demonstrates a fragment of concepts and relations instances set presented in FIG. 3a, 3b extracted by Information Extraction Unit from text presented in FIG. 2b;

FIG. 6 is a flowchart of the operations performed by Entities & Relations Merging Unit of server system shown in FIG. 1;

FIG. 7 is a flowchart of the operations performed by module of merging equal concepts instances within Entities & Relations Merging Unit shown in FIG. 6;

FIG. 8 is a flowchart of the operations performed by module of merging similar concepts instances within Entities & Relations Merging Unit shown in FIG. 6;

FIG. 9 is a flowchart of the operations performed by procedure of merging similar attributes of two concept instances within the procedure of merging similar concepts instances shown in FIG. 8;

FIG. 10 is a flowchart of the operations performed by procedure of merging relations instances other than “TheSame” type within Entities & Relations Merging Unit shown in FIG. 6;

FIG. 11 is a flowchart of the operations performed by procedure of merging relations instances of one type connected the same concepts instances within the procedure of merging relation instances shown in FIG. 10;

FIG. 12 is a flowchart of the operations performed by Store Results Unit of server system shown in FIG. 1;

FIG. 13 is a flowchart of the operations performed by procedure of merging concepts instances within Store Results Unit shown in FIG. 12;

FIG. 14 is a flowchart of the operations performed by procedure of merging relations instances within Store Results Unit shown in FIG. 12;

FIG. 15a, 15b demonstrate screenshots of an exemplary semantic information portal and Web browser with installed semantic navigation plug-in;

FIG. 16 demonstrates screenshot of Navigation Properties Unit GUI;

FIG. 17a, 17b demonstrate screenshots of Web browser with incorporated semantic navigation plug-in in switch-on state;

FIGS. 17a-1, 17a-2, 17b-1 and 17b-2 are enlargements of FIGS. 17a and 17b;

FIG. 18 is a diagram of a set of navigation scenarios supported by client system shown in FIG. 1;

FIG. 19 demonstrates screenshot of Object Navigation Card implemented within Navigation Unit of semantic navigation plug-in in client system shown in FIG. 1.

FIG. 20 demonstrates screenshot of Relation Navigation Card implemented within Navigation Unit of semantic navigation plug-in in client system shown in FIG. 1;

FIG. 21 demonstrates screenshot of Navigation Card “Person:Rupert Montagu”;

FIG. 22a, 22b demonstrate screenshots of Navigation Card for relation “Employment”;

FIG. 23a, 23b demonstrate screenshots of Navigation Card for inverse relation “Employees” for object “Montagu Newhall Associates”;

FIG. 24 demonstrates screenshot of Navigation Card “Person:Jim Lim”;

FIG. 25 demonstrates screenshot of Navigation Card “Person:Jim Lim” with panel of images related to person “Jim Lim”;

FIG. 25a, 25b are enlargements of FIG. 25;

FIG. 26 demonstrates screenshot of Professor Jim Lim Home Page;

FIG. 26a, 26b are enlargements of FIG. 26;

FIG. 27 demonstrates screenshot of Navigation Card “Person:Jim Lim” with activated History option;

FIG. 28 demonstrates screenshot of Web browser window with semantic digest generated by semantic navigation plug-in;

FIG. 28a, 28b are enlargements of FIG. 28;

FIG. 29a, 29b demonstrate screenshots of summary created on the basis of information extracted from related texts about chosen object.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

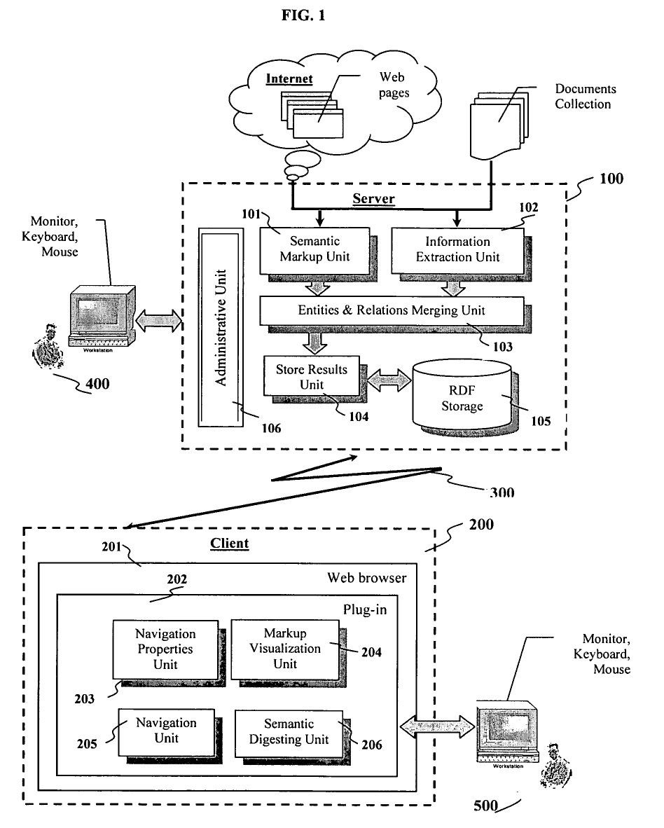

FIG. 1 depicts a general architecture of the system for semantic navigation through Web content and documents collections according to an embodiment of the present invention.

As shown in FIG. 1, a client/server model used in accordance with one embodiment of the invention includes a server system 100 and a client system 200 linked via network 300. In general, well-known client/server model describes relations between two computer programs where one program (the client) asks a service from another program (the server) that processes received request and returns needed results to the client. Client/server model provides a convenient approach to interconnect programs distributed across different locations. Interconnection between client and server usually is supported by HTTP-protocol.

Referring to FIG. 1, server system 100 consists of six modules: Manual Semantic Markup Unit 101, Information Extraction Unit 102, Entities & Relations Merging Unit 103, Store Results Unit 104, RDF Storage 105, and Administrative Unit 106, as well. According to an embodiment of the present invention Manual Semantic Markup Unit 101 functionality is connected with manual markup of Web pages presented in Internet and/or Documents presented in corporative collections by human expert 400 who should explicitly to outline Named Entities and Relations between them within the text and to present markup results in OWL-format. Functionality of Information Extraction Unit 102 is connected with automatic extraction from the text Named Entities and Relations between them according to disclosure of Russian Patent No 2242048, filed on Feb. 18, 2003, in the Russian Federal Service for Intellectual Property, Patents and Trademarks (ROSPATENT), and automatic representation of results in OWL-format. Entities & Relations Merging Unit 103 fulfills the search of the same Named Entities and Relations extracted from one text and merges each set of the same Named Entities into single Named Entity and each set of the same Relations into single Relation respectively. Merging results presented in OWL-format pass to Store Results Unit 104 to check their presence in RDF Storage 105 and additional merging Named Entities and Relations that already exist in RDF Storage 105 with new Named Entities and Relations. Then merging results presented in OWL-format pass to RDF Storage 105 for further usage by client system 200. Administrative Unit 106 is destined to control communication between other server components course all of them may run in different memory spaces on one computer or on different computers linked via a network using HTTP-protocol. Within distributed framework each of the system 100 can be implemented as multi agent system whose special agents are server units 101, 102, 103, 104 and their broker is Administrator Unit 106.

The disclosed server system 100 may be highly scalable, so allows a different configurations and embodiments. For example, several agents implemented as text processors like MS Word with export of the results into OWL-format can present Manual Semantic Markup Unit 101, another agents that implement information extraction functionality for different natural languages and different domain can present Information Extraction Unit 102, many agents that fulfill Named Entities and Relations merging presented by Entities & Relations Merging Unit 103 can do it's job in parallel, and many agents that fulfill additional merging of Named Entities and Relations that already exist in RDF Storage 105 with new Named Entities and Relations presented by Store Results Unit 104 can do it's job in parallel too, and several brokers that are, in fact, clones of Administrative Unit 106 can manage all other agents and RDF Storage 105.

Referring to FIG. 1 again, client system 200 is represented by special navigation plug-in 202 incorporated into Web browser 201 that is a client program used HTTP-protocol to request Web servers (e.g. server system 100) via Internet connection 300 on behalf of a user 500. In general, a plug-in is an application program, easy installed and used as a part of Web browser (e.g. Web browser 201). A plug-in 202 is recognized by Web browser 201 automatically, and its functionality is integrated into a HTML-file that is being presented to a user 500. According to an embodiment of the present invention navigation plug-in 202 consists of four modules: Navigation Properties Unit 203, Markup Visualization Unit 204, Navigation Unit 205, and Semantic Digesting Unit 206. Functionality of Navigation Properties Unit 203 is connected with set-up address of appropriate server system 100 and definition of communication language. Markup Visualization Unit 204 visualizes Web page or document semantic markup received by client system 200 from server system 100. Navigation Unit 205 supports semantic navigation across Web pages and/or documents already processed by server system 100, and Semantic Digesting Unit 206 is destined to generate digests reflected a user's navigation paths.

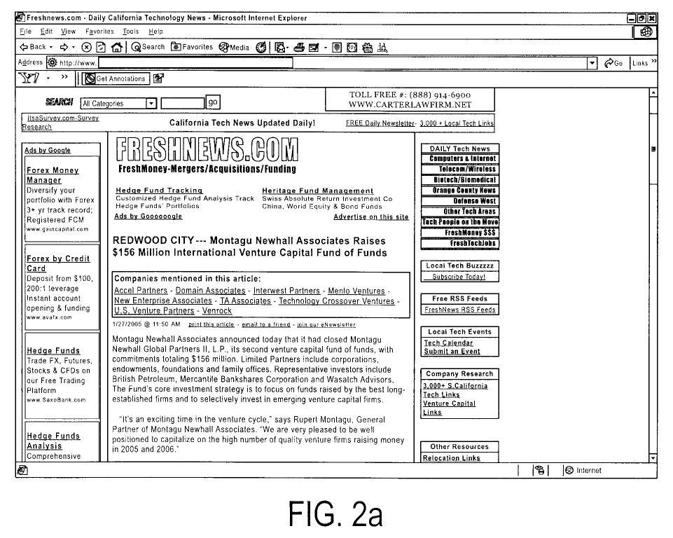

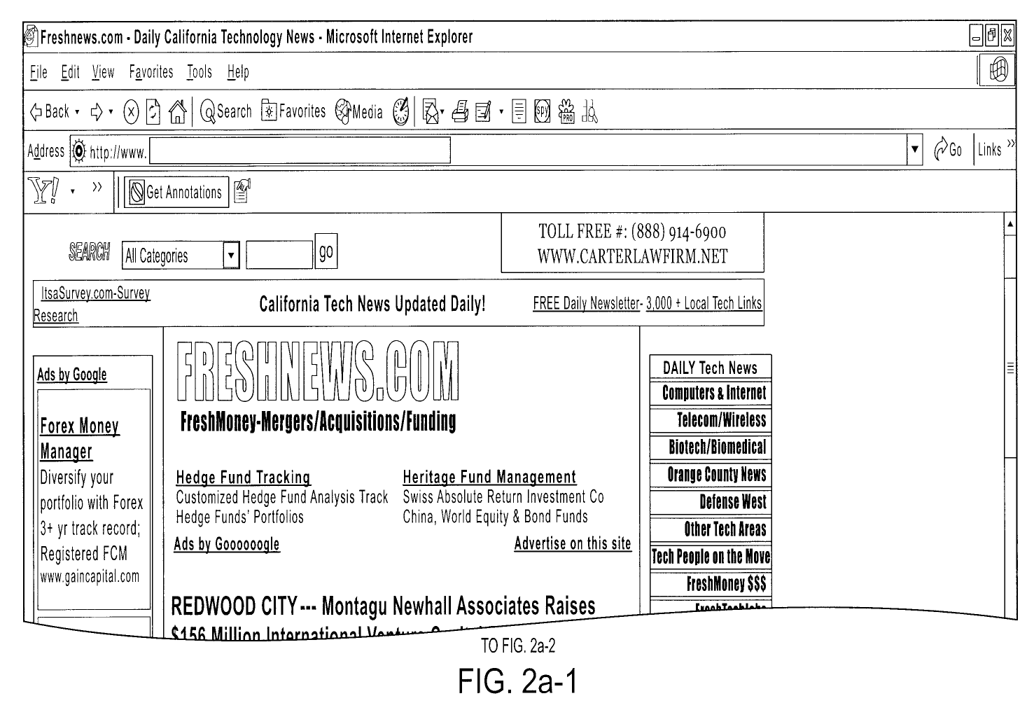

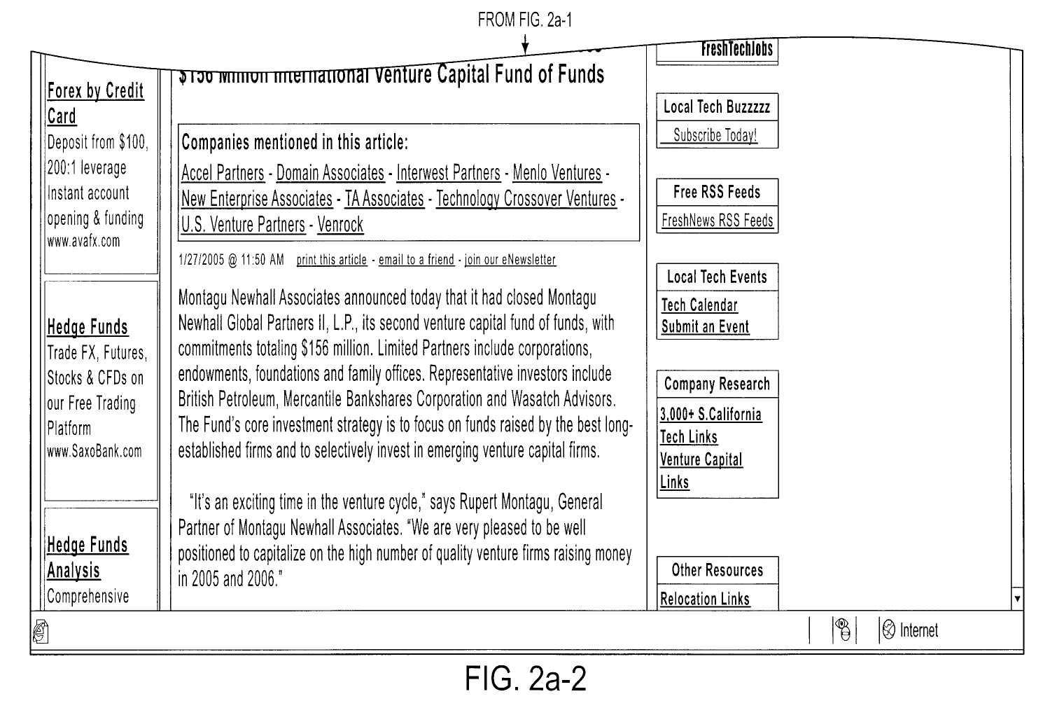

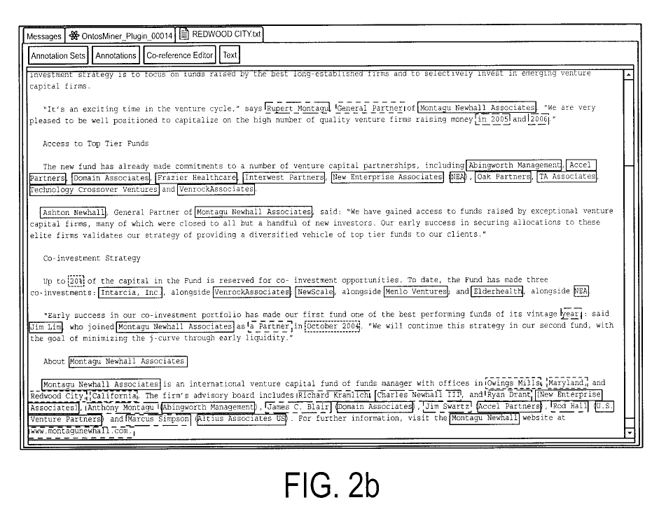

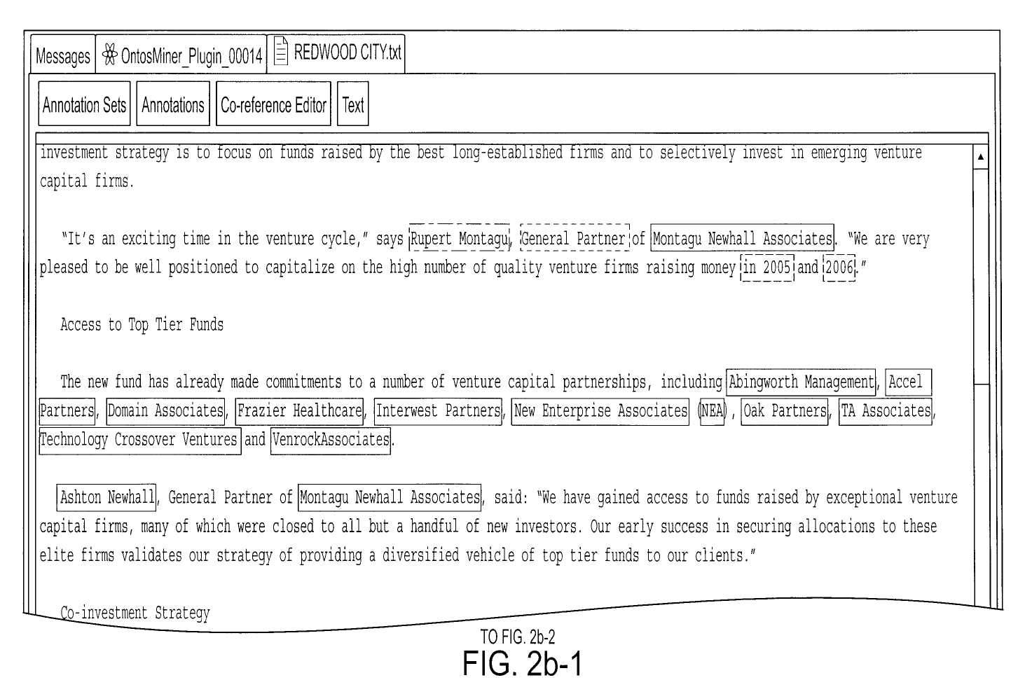

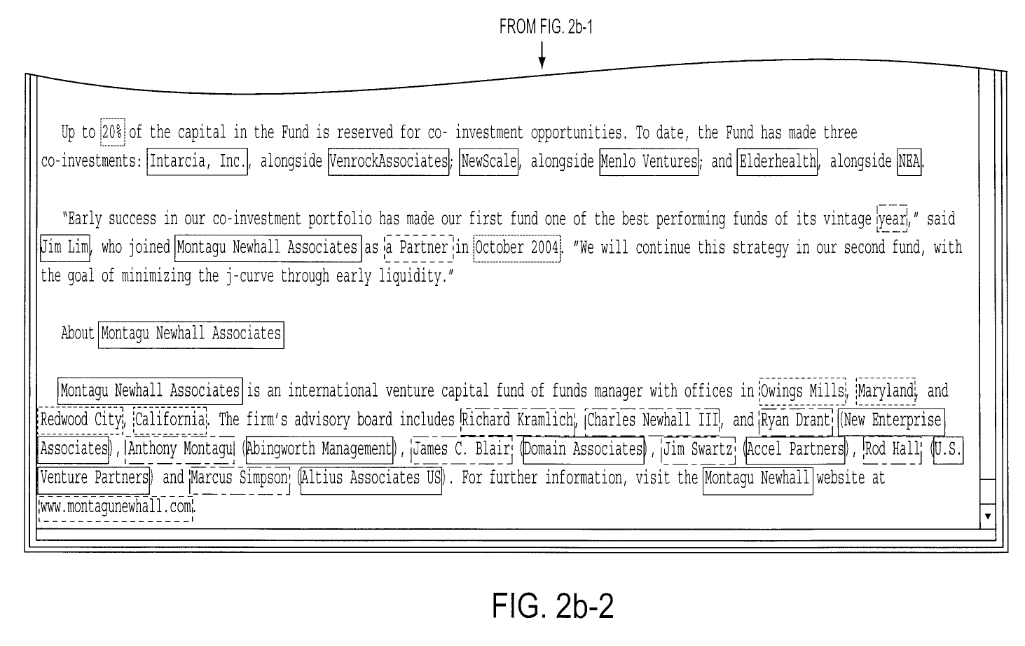

FIG. 2 illustrates semantic markup Web page within server system shown in FIG. 1.

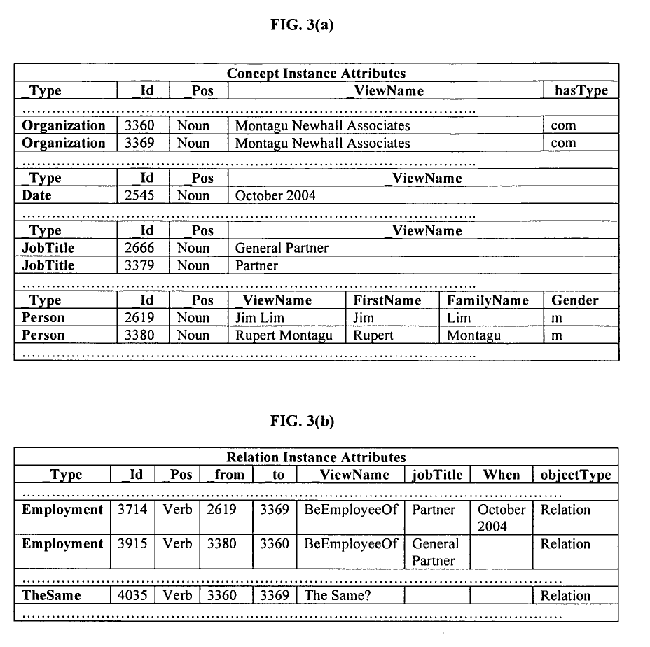

In FIG. 2a, for example, presented Web page from site http://www.freshnews.com. According to the embodiments of the present invention this page should be transformed into plain text format and processed by Manual Semantic Markup Unit 101 or Information Extraction Unit 102 in server system 100. Results of above depicted processing presented in FIG. 2b, where each type of markup objects highlighted, for convenience, its own color. In both cases (e.g. processing text with Manual Semantic Markup Unit 101 or Information Extraction Unit 102) the output results should be presented in OWL format that can be at the logical level reflected by relational table. A fragment of such logical representation generated by Information Extraction Unit 102 implemented according to disclosure of Russian Patent No 2242048, filed on Feb. 18, 2003, in the Russian Federal Service for Intellectual Property, Patents and Trademarks (ROSPATENT) presented in FIG. 3.

Referring to FIG. 3a, each concept instance has system attributes (e.g. _Type, _Id, _Pos, and _ViewName) and business attributes, specific to each type of concept. For example, concept of Organization type has additional business attribute hasType with the following alternative values: com (commercial), edu (educational), mil (military), etc., and concept Person has additional business attributes FirstName, FamilyName, and Gender. According to domain model another types of concepts have another business attributes.

Referring to FIG. 3b, each relation instance has system attributes (e.g. _Type, _Id, _Pos, _from, _to, objectType, and _ViewName) and business attributes, specific to each type of relation. For example, relation of Employment type has additional facultative business attributes jobTitle and When, and relation of TheSame type has no additional business attributes. According to domain model another types of relations have or haven't another business attributes.

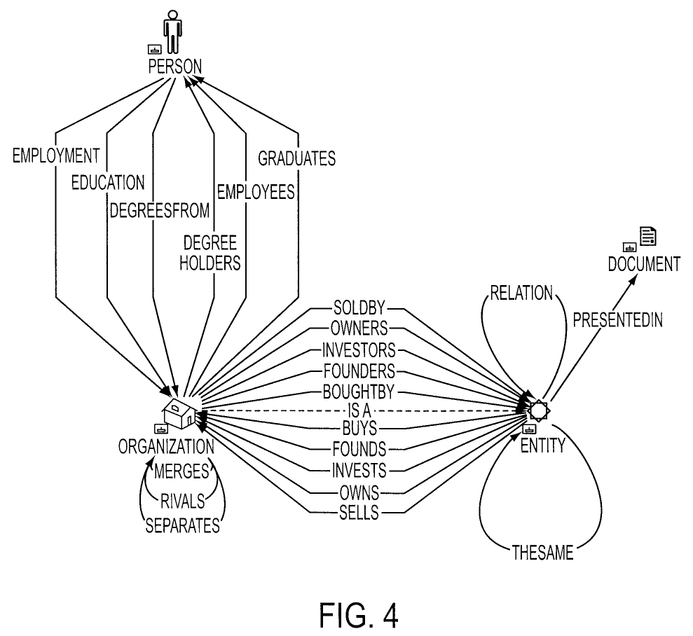

FIG. 4 presents a fragment of domain ontology used by Information Extraction Unit to control text mining.

Referring to FIG. 4, domain ontology is the oriented graph with nodes representing concepts and links between them representing semantic relations between concepts.

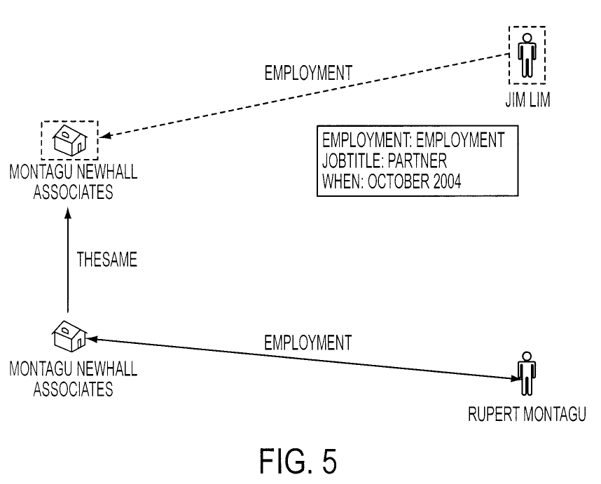

FIG. 5 demonstrates a fragment of concepts and relations instances set presented in FIG. 3 (a, b) extracted by Information Extraction Unit from text presented in FIG. 2 (b).

Referring to FIG. 5, there are two instances of concept of Organization type, two instances of concept of Person type, two instances of concept of Employment type, and one instance of concept of The Same? type presented in this fragment of semantic representation of the text shown in FIG. 2 (b) according to extracted Named Entities and Relations shown in FIG. 3, while instances of concepts Date and JobTitle types are just attributes of appropriate instances of concept Employment type.

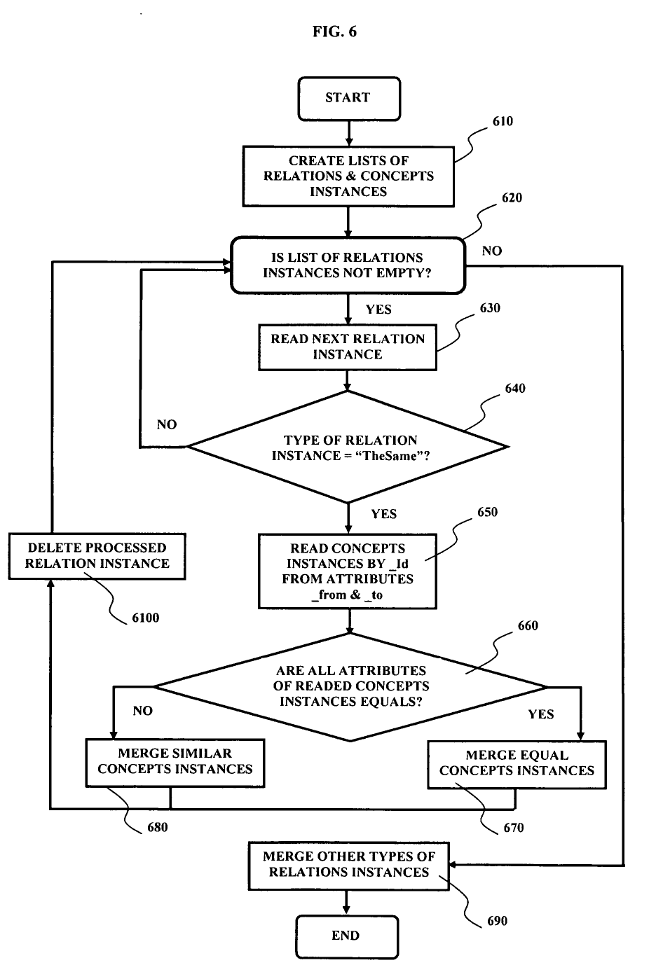

FIG. 6 is a flowchart of the operations performed by Entities & Relations Merging Unit of server system shown in FIG. 1.

Referring to FIG. 6, Entities & Relations Merging Unit 103 creates lists of relations and concepts instances extracted from the text with operator 610, organizes with cycle operator 620 of WHILE type the processing of each relation instance presented in the list of relations instances while it is not empty by reading next relation instance with operator 630, checks if type of this relation instance is equal to “TheSame” with operator 640, and if not so, continue the cycle with cycle operator 620. Otherwise operator 650 reads concepts instances depicted by their unique identifiers presented as values of _from and _to attributes in current relation instance, checks if all attributes of read concepts instances are equals with operator 660, and if so, jumps to the merging equal concepts instances with procedure 670, and after the finishing this procedure processed relation instance of “TheSame” type is deleted with operator 6100, and execution control flow shifts to the operator 620. Otherwise merging of similar concepts instances fulfilled with procedure 680, and after the finishing this procedure processed relation instance of “TheSame” type is deleted with operator 700, and control flow shifts to the operator 620. If all of instances of relations from list of relations instances are already processed, control flow jumps to the merging of other types of relations instances with procedure 690, and then control flow jumps to end.

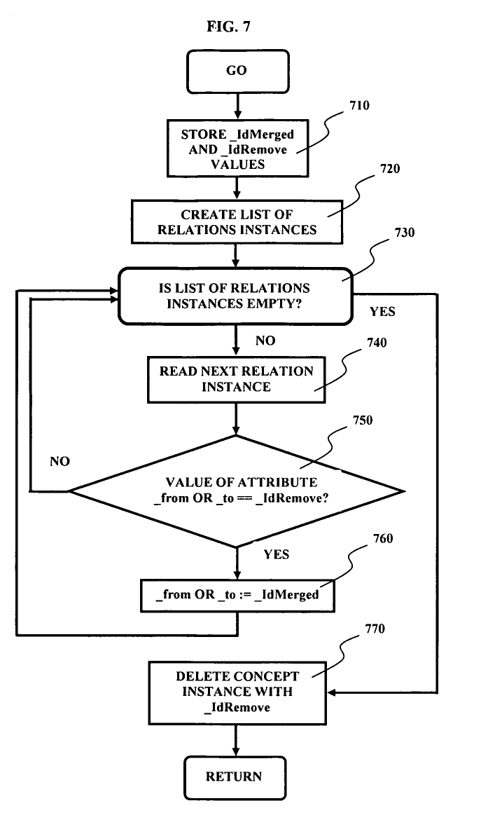

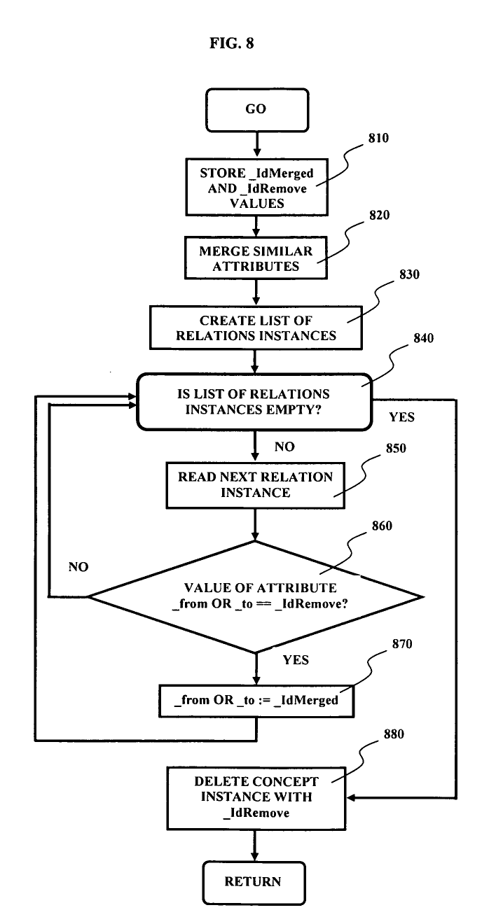

FIG. 7 is a flowchart of the operations performed by procedure of merging equal concepts instances within Entities & Relations Merging Unit shown in FIG. 6.

Referring to FIG. 7, procedure of merging equal concepts instances 670 stores from processing relation instance of “TheSame” type the value of attribute _to as _IdMerged and the value of attribute _from as _IdRemove with operator 710, creates lists of relations instances extracted from the text with operator 720, organizes with cycle operator 730 of WHILE type the processing of each relation instance presented in the list of relations instances while it is not empty by reading next relation instance with operator 740, checks if value of attribute _from or _to in this relation instance is equal to _IdRemove with operator 750, and if so, changes the value of attribute _from or _to at the value of _IdMerged with operator 760. Otherwise continue the cycle with cycle operator 730. After processing of all of instances of relations from list of relations instances control flow shifts to the operator 770 to delete concept instance with _IdRemove, and after this action control flow returns to the main stream.

FIG. 8 is a flowchart of the operations performed by procedure of merging similar concepts instances within Entities & Relations Merging Unit shown in FIG. 6.

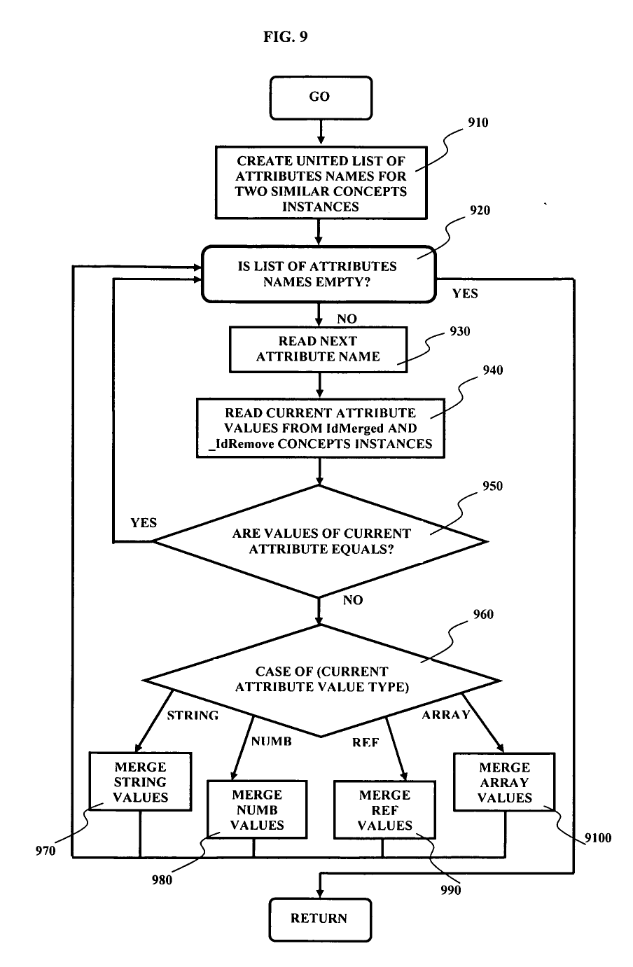

Referring to FIG. 8, procedure of merging similar concepts instances 680 fulfills all operators of procedure of merging equal concepts instances 670 shown in FIG. 7, besides processing of similar attributes of two concept instances with procedure 810 presented in FIG. 9.

FIG. 9 is a flowchart of the operations performed by procedure of merging similar attributes of two concept instances within the procedure of merging similar concepts instances shown in FIG. 8.

Referring to FIG. 9, procedure of merging similar attributes of two concept instances 810 creates united list of attributes names for two similar concepts instances with operator 910, organizes with cycle operator 920 of WHILE type the processing of each attribute name presented in the list while it is not empty by reading next attribute name with operator 930, reads current attribute values from IdMerged and _IdRemove concepts instances with operator 940, checks if values of current attribute are equal with operator 950, and if so, continue the cycle with cycle operator 920. Otherwise fulfills branch operator 960 of CASE type with parameter “current attribute value type”, and if this parameter equals STRING fulfills operator 970 to merge two values according to the following rule: if one value is substring of another, overlap string choused as merged value, otherwise longest string choused as merged value, if this parameter equals NUMB fulfills operator 980 to merge two values according to the following rule: maximum from two values choused as merged value, if this parameter equals REF fulfills operator 990 to merge two values according to the following rule: type of merged value changed from REF into ARRAY and both values stored as merged value of attribute, and if this parameter equals ARRAY fulfills operator 9100 to store both arrays of values as single array without duplicates. After merging values of current attribute control flow shifts to the operator 920 to continue cycle of processing other attributes values. If all values of all attributes of two similar concepts instances are processed, control flow returns to the main stream.

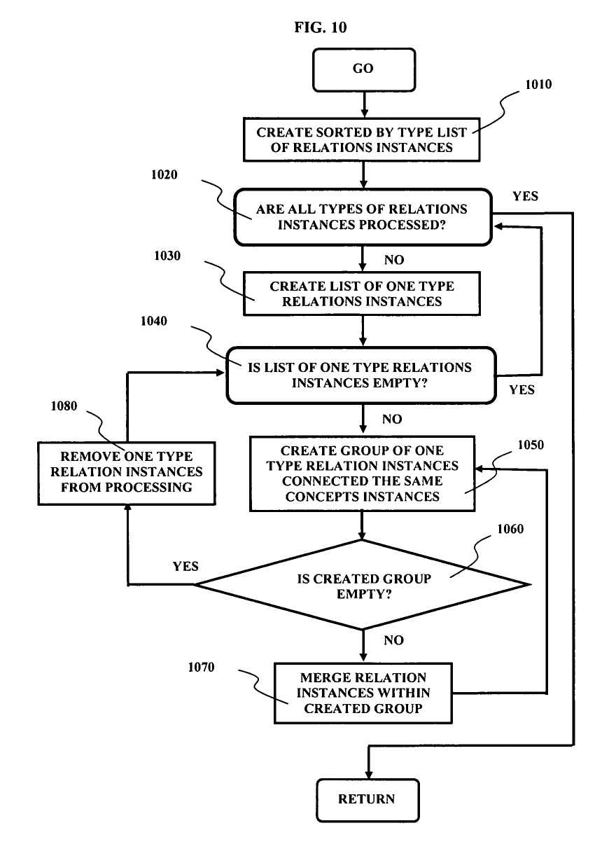

FIG. 10 is a flowchart of the operations performed by procedure of merging relations instances other than “TheSame” type within Entities & Relations Merging Unit shown in FIG. 6.

Referring to FIG. 10, procedure 690 of merging relations instances other than “TheSame” type creates sorted by type list of relations instances with operator 1010, organizes with cycle operator 1020 of WHILE type the processing of each type of relations instances presented in the list while it is not empty by creating list of one type relations instances with operator 1030, and organizes with cycle operator 1040 of WHILE type the processing of all relations instances of one type by creating group of one type relation instances connected the same concepts instances with operator 1050, checks if created group is not empty with operator 1060, and if so, merge relation instances within created group with procedure 1070, and after this action shifts control flow to operator 1050 to create new group of one type relation instances connected the same concepts instances. Otherwise fulfills operator 1080 to remove one type relation instances from processing, and shifts control flow to operator 1040 to continue cycle of processing other lists of one type relations instances. If all types of relations instances are processed, control flow returns to the main stream.

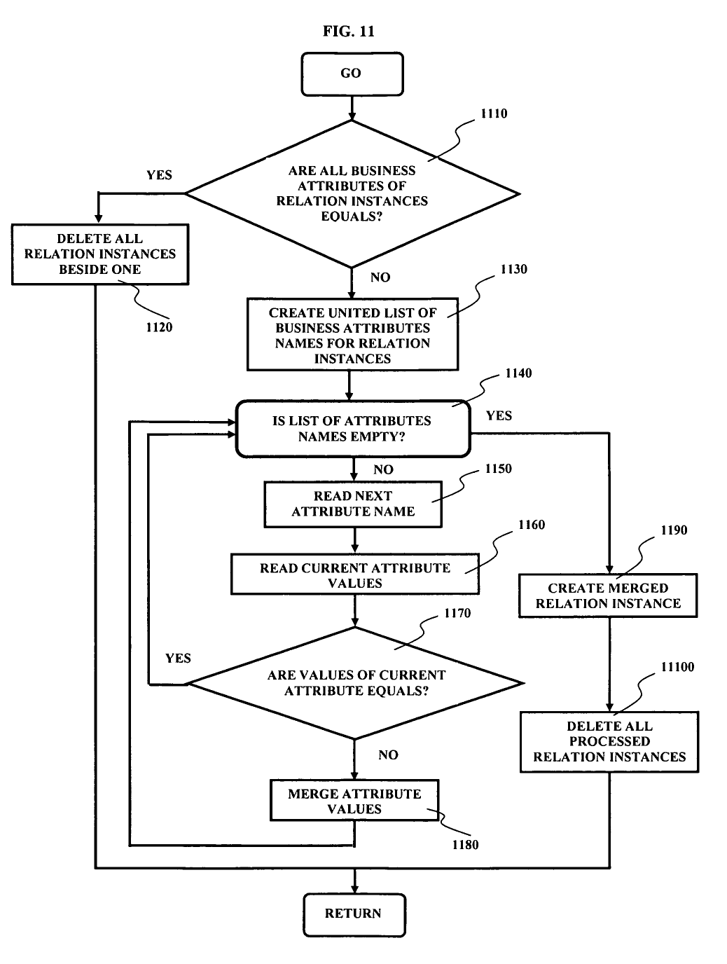

FIG. 11 is a flowchart of the operations performed by procedure of merging relations instances of one type connected the same concepts instances within the procedure of merging relation instances shown in FIG. 10.

Referring to FIG. 11, procedure 1070 of merging relations instances of one type connected the same concepts instances checks with operator 1110 if all business attributes of relation instances are equal, and if so, delete all relation instances beside one with operator 1120, and returns control flow to the main stream. Otherwise creates united list of business attributes names for relation instances with operator 1130, organizes with cycle operator 1140 of WHILE type the processing of all relations instances attributes names, reads next attribute name with operator 1150, reads all values for this attribute with operator 1160, checks with operator 1170 if all values of current attribute are equal, and if so, shifts control flow to operator 1140 to continue cycle of all attributes names processing. Otherwise merges all values of current attribute by creating array of these values without duplicates with operator 1180, and after this action shifts control flow to operator 1140 to continue cycle of all attributes names processing. If all attribute names are processed, creates merged relation instance with operator 1190, deletes all processed relation instances with operator 11100, and after this action returns control flow to the main stream.

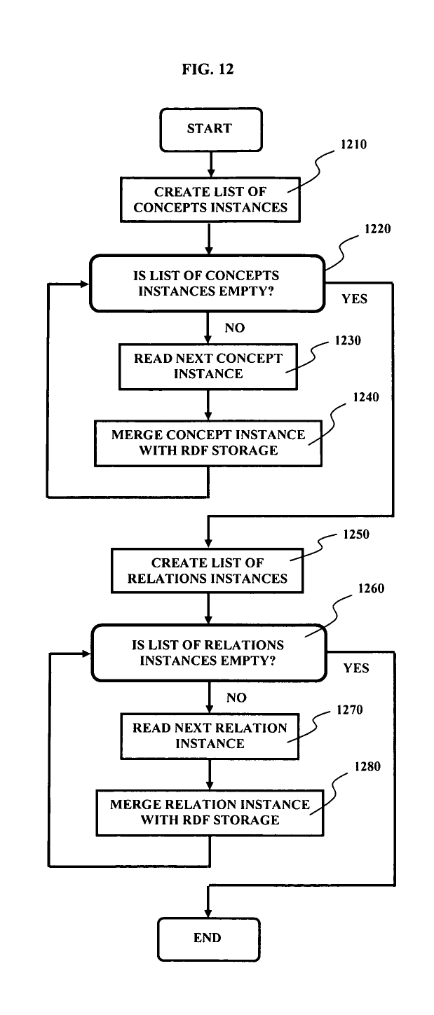

FIG. 12 is a flowchart of the operations performed by Store Results Unit of server system shown in FIG. 1.

Referring to FIG. 12, Store Results Unit 104 creates list of concepts instances with operator 1210, organizes with cycle operator 1220 of WHILE type the processing of each concepts instance presented in the list while it is not empty by reading next concepts instance with operator 1230, merges this concept instance with RDF storage with procedure 1240, and after this action shifts control flow to operator 1220 to continue cycle for all concepts instances. If all concepts instances are processed, creates list of relations instances with operator 1250, organizes with cycle operator 1260 of WHILE type the processing of each relations instance presented in the list while it is not empty by reading next relations instance with operator 1270, merges this relation instance with RDF storage with procedure 1280, and after this action shifts control flow to operator 1260 to continue cycle for all relations instances. After processing all concepts and relations instances control flow jumps to end.

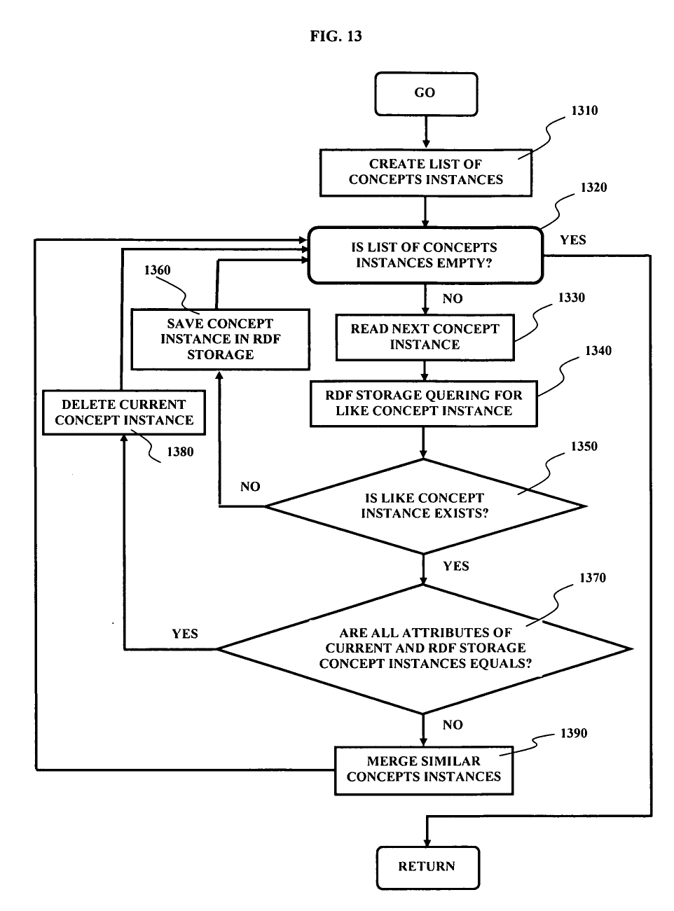

FIG. 13 is a flowchart of the operations performed by procedure of merging concepts instances within Store Results Unit shown in FIG. 12.

Referring to FIG. 13, procedure 1240 of merging concepts instances creates list of concepts instances with operator 1310, organizes with cycle operator 1320 of WHILE type the processing of each concepts instance presented in the list while it is not empty by reading next concepts instance with operator 1330, queries RDF Storage 105 for like concept instance with operator 1340, checks with operator 1350 if such concept instance is already exists in RDF Storage 105, and if not so, saves current concept instance with operator 1360 into RDF Storage 105, and shifts control flow to operator 1320 to continue cycle of all concepts instances processing. Otherwise checks if all attributes of current and RDF storage concept instances are equals, and if so, deletes current concept instance with operator 1380, and shifts control flow to operator 1320 to continue cycle of all concepts instances processing, otherwise merges similar concepts instances with procedure 1390 which flowchart shown in FIG. 9, and shifts control flow to operator 1320 to continue cycle of all concepts instances processing. After processing all concepts instances returns control flow to the main stream.

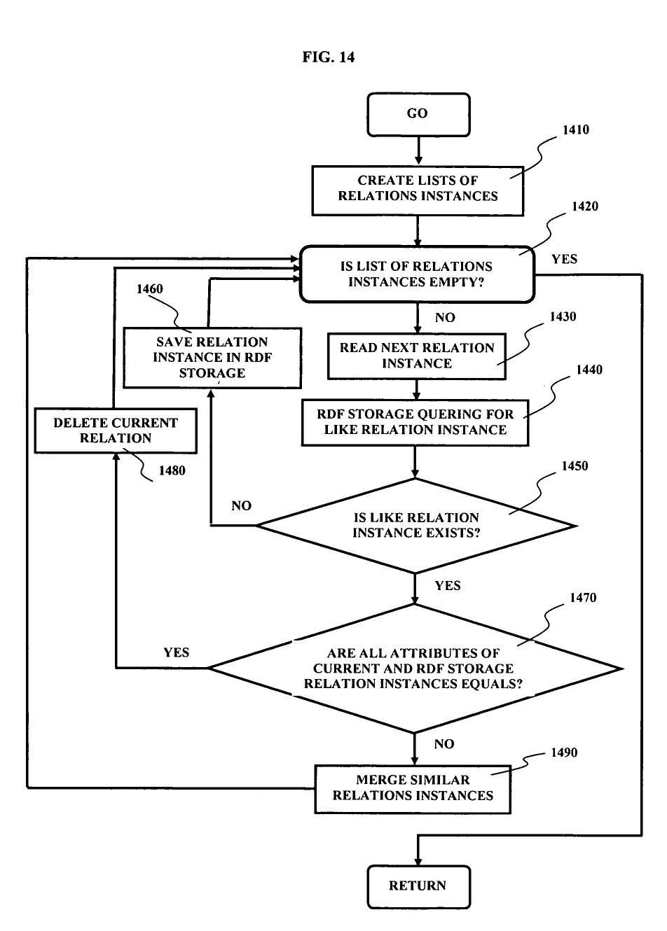

FIG. 14 is a flowchart of the operations performed by procedure of merging relations instances within Store Results Unit shown in FIG. 12.

Referring to FIG. 14, procedure 1280 of merging relations instances creates list of relations instances with operator 1410, organizes with cycle operator 1420 of WHILE type the processing of each relations instance presented in the list while it is not empty by reading next relations instance with operator 1430, queries RDF Storage 105 for like relation instance with operator 1440, checks with operator 1450 if such relation instance is already exists in RDF Storage 105, and if not so, saves current relation instance with operator 1460 into RDF Storage 105, and shifts control flow to operator 1420 to continue cycle of all relations instances processing. Otherwise checks if all attributes of current and RDF storage relation instances are equals, and if so, deletes current relation instance with operator 1480, and shifts control flow to operator 1420 to continue cycle of all relations instances processing, otherwise merges similar relations instances with procedure 1490 which flowchart shown in FIG. 10, and shifts control flow to operator 1420 to continue cycle of all relations instances processing. After processing all relations instances returns control flow to the main stream.

As a result of execution of all above presented procedures and operators new concepts and relations instances will be stored into RDF Storage 105 for further usage by client system 200.

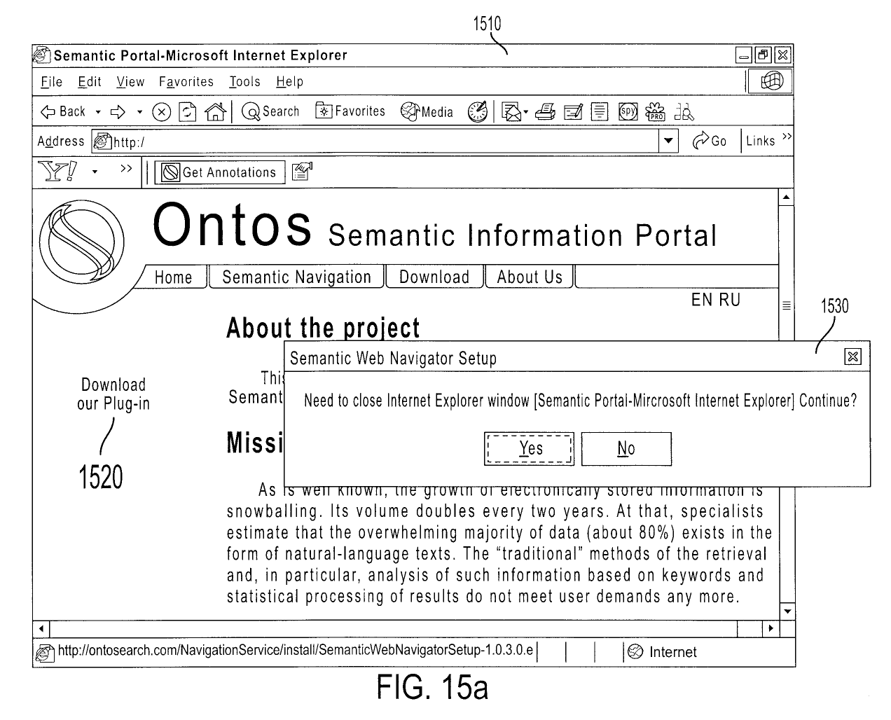

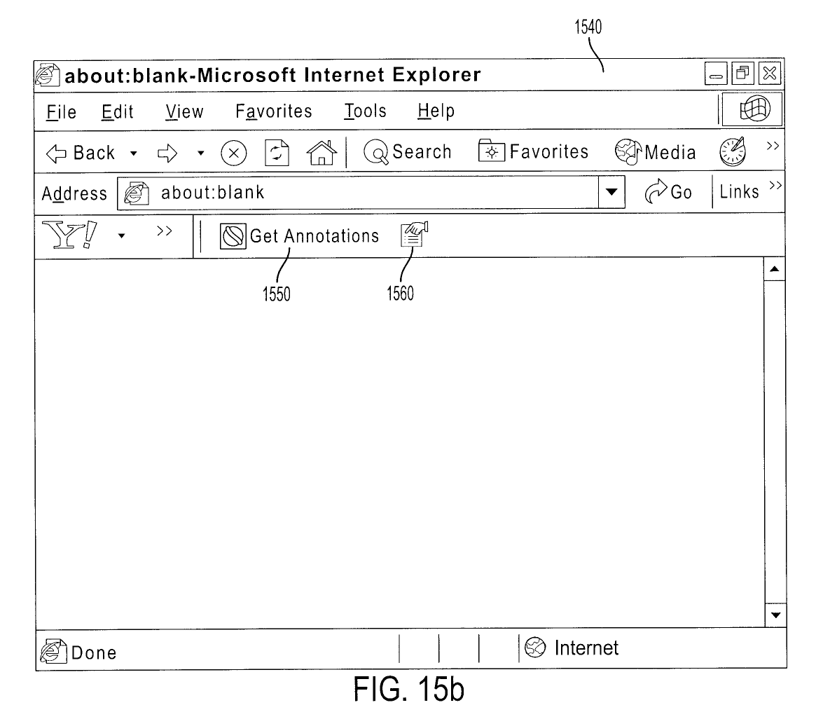

FIG. 15a, 15b demonstrate screenshots of an exemplary semantic information portal and Web browser with installed semantic navigation plug-in.

According to an embodiment of the present invention and referring to FIG. 15a, a user can visit Ontos Semantic Information Portal 1510 to click hyperlink 1520, and run Semantic Web Navigator Setup 1530 to install semantic navigation plug-in 202 depicted in FIG. 1 within client system 200.

According to an embodiment of the present invention and referring to FIG. 15b, the result of plug-in 202 installation presented within Web browser (for example, within Microsoft Internet Explorer 1540) as two buttons, including: button 1550 to start Navigation Properties Unit 203 and button 1560 to switch on/off Markup Visualization Unit 204 depicted in FIG. 1 within client system 200.

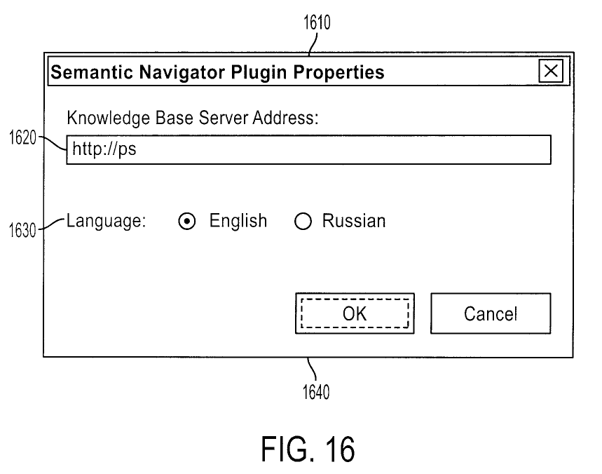

FIG. 16 demonstrates screenshot of Navigation Properties Unit GUI.

Referring to FIG. 16, Navigation Properties Unit 203 GUI 1610 provides three controls, including: set Knowledge Base Server Address 1620 to define connection with server system 100 depicted in FIG. 1, set language 1630 to fix interface language, and two buttons 1640 (“OK” to confirm and “Cancel” to cancel depicted settings).

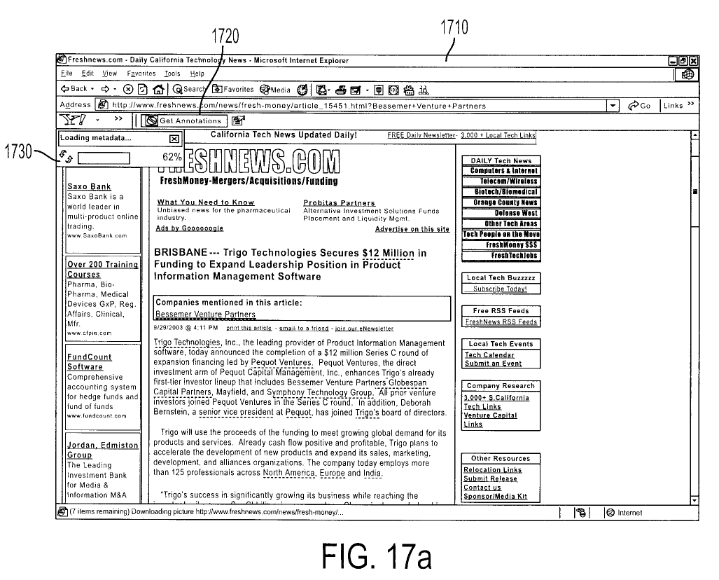

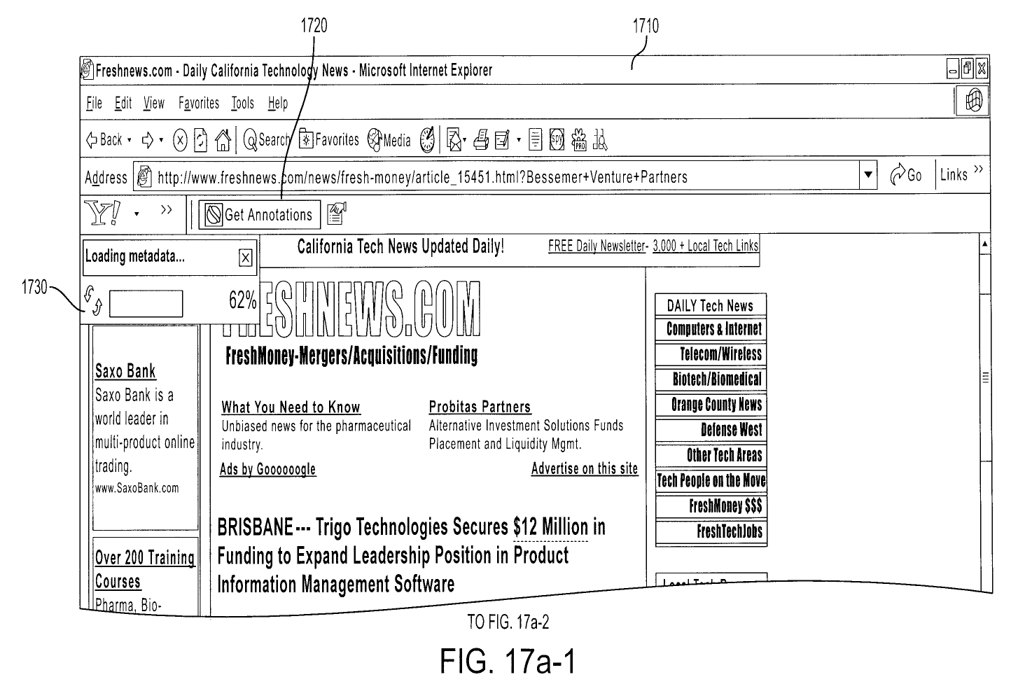

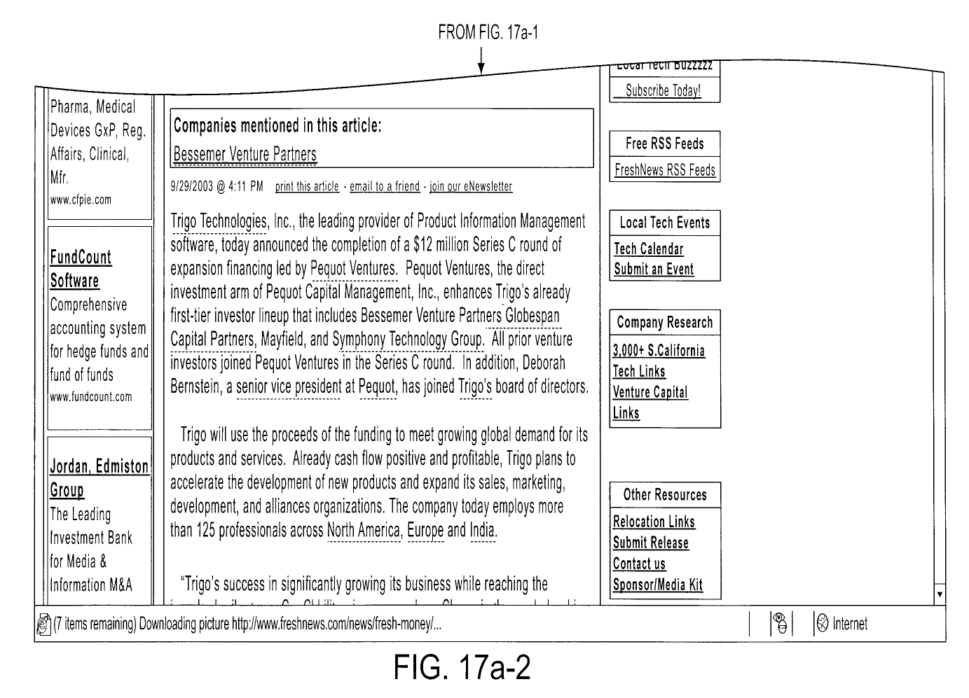

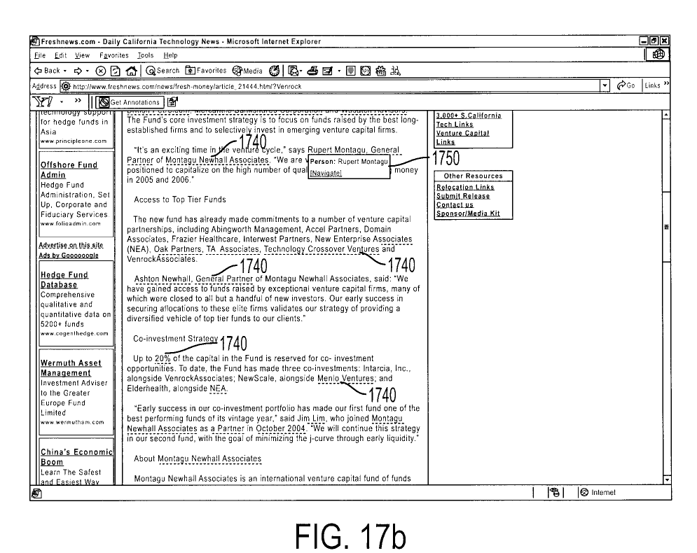

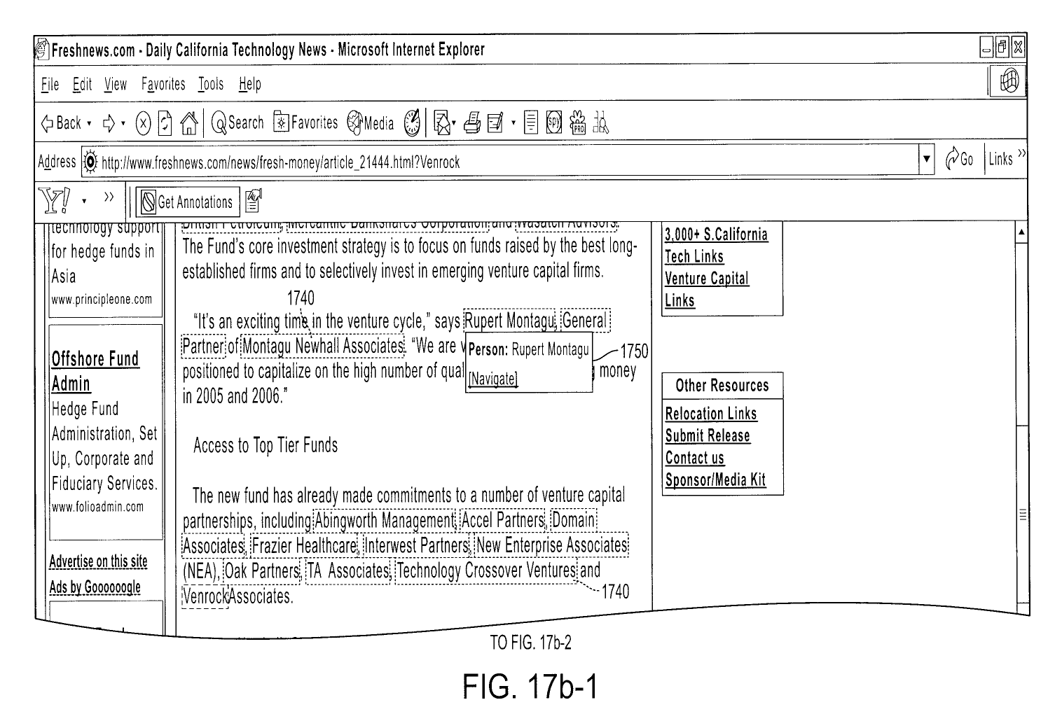

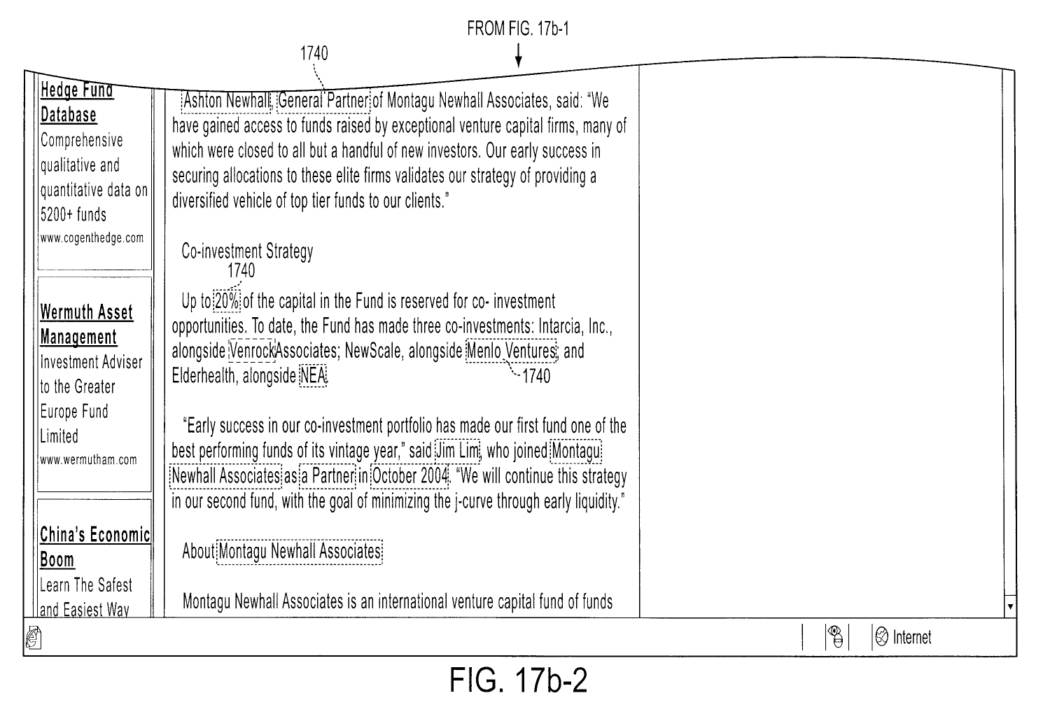

FIG. 17 demonstrates screenshot of Web browser with incorporated semantic navigation plug-in in switch-on state.

Referring to FIG. 17a, Markup Visualization Unit 204 within semantic navigation plug-in incorporated into Web browser (for example, into Microsoft Internet Explorer 1710) being activated automatically when a user requests Web page already processed by server system 100 depicted in FIG. 1, or can be explicitly activated by a user with button 1720. In both cases special request dispatches to server system 100 in compliance with Knowledge Base Server Address preset in Navigation Properties Unit GUI 1610 shown in FIG. 16, and, as a result of processing this request, server system 100 returns to semantic navigation plug-in 202 (e.g. to Markup Visualization Unit 204) appropriate markup extracted from RDF Storage 105 depicted in FIG. 1. Client-server communication and markup visualization process reflected in semantic markup progress bar 1730, and after the finishing of these processes a user can see markup 1740 shown in FIG. 17b and to start semantic navigation itself from one of marked up Named Entities through Navigation Card tip with hyperlink 1750.

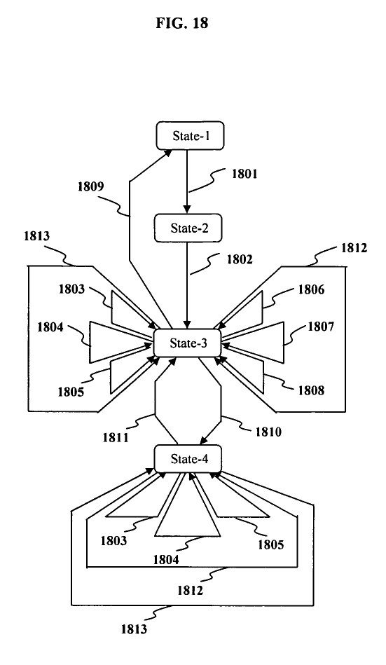

FIG. 18 is a diagram of a set of business scenarios supported by client system shown in FIG. 1.

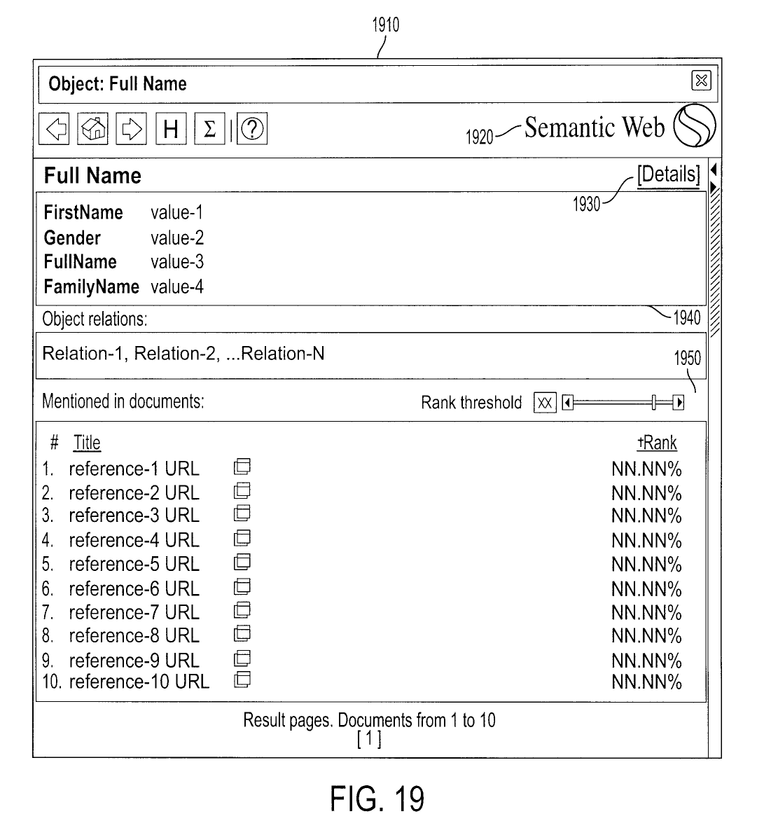

According to an embodiment of the present invention and referring to FIG. 18, semantic navigation plug-in 202 depicted in FIG. 1 within client system 200 supports, beside usual navigation actions supported by Web browser, a set of semantic navigation actions, including (beside others): action 1801—choose with mouse an object of interest (e.g. marked up Named Entity), action 1802—open Object Navigation Card presented in FIG. 19 via Navigation Card tip shown in FIG. 17b.

FIG. 19 demonstrates screenshot of Object Navigation Card implemented within Navigation Unit of semantic navigation plug-in in client system shown in FIG. 1.

Referring to FIG. 19, an Object Navigation Card 1910 provides four panels, including: Navigation Panel Toolbar 1920 with Ontos logo and Previous, Start, Next, History, Summary and Help buttons, Current Object Panel 1930 where current object view name, current object attributes with their values, and option Details to hide/visualize current object attributes are present, Current Object Relations Panel 1940 where semantic relations of current object depicted, and Current Object References Panel 1950 accompanied with a list of ranking URLs related to current object and semantic threshold thermometer control.

Referring to FIG. 18 again, semantic navigation plug-in 202 depicted in FIG. 1 within client system 200 supports within an Object Navigation Card 1910 a set of additional semantic navigation actions, including: action 1803—backward to Previous point of semantic navigation process, action 1804—return to Start point of semantic navigation process, action 1805—forward to Next point of semantic navigation process, action 1806—look through references related to current object, action 1807—change rank threshold of references related to current object with semantic threshold thermometer control to extend/restrict the number of references where current object is mentioned, action 1808—hide/visualize current object attributes, action 1809—choose reference to open linked Web page in new/same browser window, and action 1810—open Relation Navigation Card for one of semantic relations of current object.

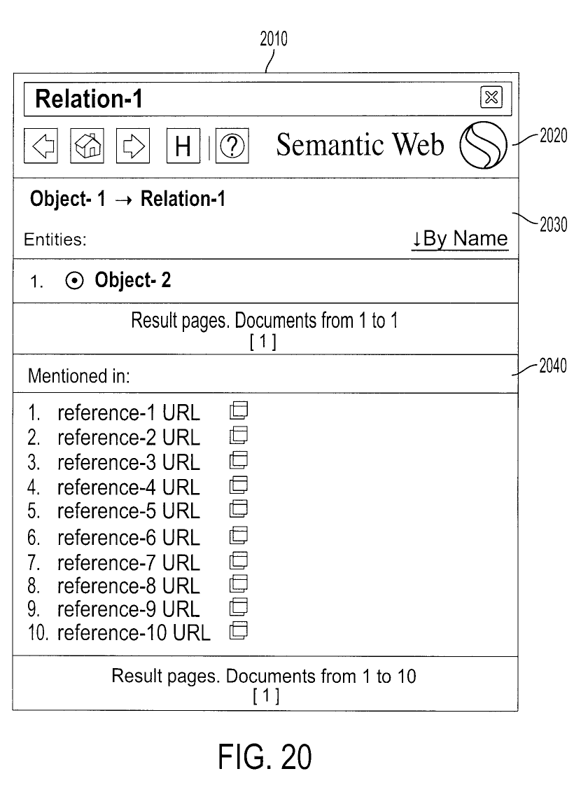

Referring to FIG. 19 again, a user can choose one of semantic relations of current object presented in Current Object Relations Panel 1940 to open Relation Navigation Card shown in FIG. 20.

FIG. 20 demonstrates screenshot of Relation Navigation Card implemented within Navigation Unit of semantic navigation plug-in in client system shown in FIG. 1.

Referring to FIG. 20, a Relation Navigation Card 2010 provides three panels, including: Navigation Panel Toolbar 2020 that is, in fact, Navigation Panel Toolbar 1920, Current Relation Panel 2030 where current object-relation pair view name is presented in a header, and sorted (with option “By Name”) list of objects connected with current object by current relation is depicted (one of list element can be checked with a radio button connected with this element), and Current Relation References Panel 2040 accompanied with a list of URLs related to current object-relation pair.

Referring to FIG. 18 again, semantic navigation plug-in 202 depicted in FIG. 1 within client system 200 supports within a Relation Navigation Card 2010 a set of additional semantic navigation actions, including: navigation actions 1803, 1804, 1805, and action 1811—open Object Navigation Card for one of the objects connected with current object by current relation.

Referring to FIG. 18 again, semantic navigation plug-in 202 depicted in FIG. 1 within client system 200 supports within an Object Navigation Card 1910 and a Relation Navigation Card 2010, as well, a set of additional semantic navigation actions, including: action 1812—show navigation history accompanied with an option of generation of semantic Digest for objects and relations presented in navigation history created on the basis of information extracted from related texts, action 1813—generation of summary created on the basis of information extracted from related texts about chosen object.

Semantic Navigation Example

To clarify the present invention an example of semantic navigation session illustrated with the accompanying screenshots, wherein like reference numerals refer to the like elements throughout is presented below.

According to an embodiment of the present invention, semantic navigation process can be started from any Web page or document previously processed by server system 100 shown in FIG. 1. Let's suppose that semantic navigation plug-in 202 within client system 200 shown in FIG. 1 is already installed and a user starts semantic navigation, for example, from Web page published at site http://www.freshnews.com. Semantic markup of this page presented in FIG. 17a, 17b.

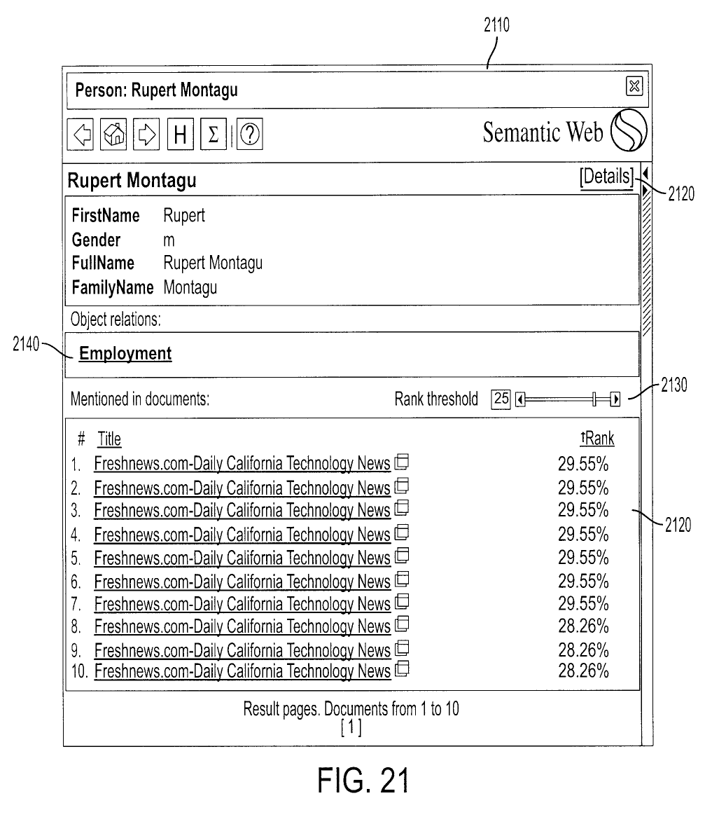

Referring to FIG. 18, a user is in the State-1 of navigation scenario supported by client system 200 shown in FIG. 1 and can look through page markup. Let's suppose that a user is interested in person “Rupert Montagu” and his relations with different organizations, other persons, etc. In such a case, he(she) can open Object Navigation Card related to this person (e.g. Navigation Card “Person:Rupert Montagu” 2110 shown in FIG. 21) by click hyperlink Navigate within Navigation tip 1750 presented in FIG. 17b. After this action semantic navigation plug-in 202 switches to State-2 of navigation scenario shown in FIG. 18.

FIG. 21 demonstrates screenshot of Navigation Card “Person:Rupert Montagu”.

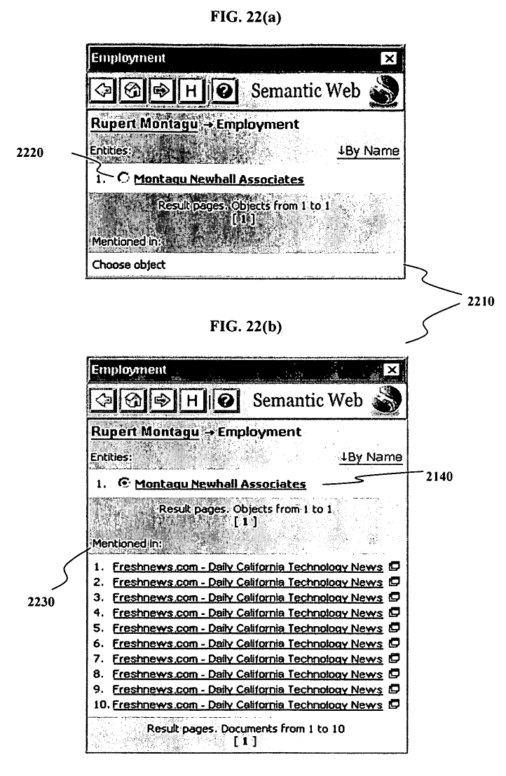

Referring to FIG. 21, within Navigation Card “Person:Rupert Montagu” 2110 a user can hide/visualize person's attributes with option 2120, look at related to this person references with their semantic ranking, change rank threshold using Threshold Thermometer 2130 (in such a case a number of related references may be will change), choose one of the related reference to open linked Web page in new/same browser window, click on object relations instance (e.g. Employment relation 2140), and, as a result, open Relation Navigation Card related to this relation (e.g. Navigation Card “Employment” 2210) shown in FIG. 22a. After this action requested Relation Navigation Card will be presented to a user and semantic navigation plug-in 202 switches to State-3 of navigation scenario shown in FIG. 18.

FIG. 22a, 22b demonstrate screenshots of Navigation Card for relation “Employment”.

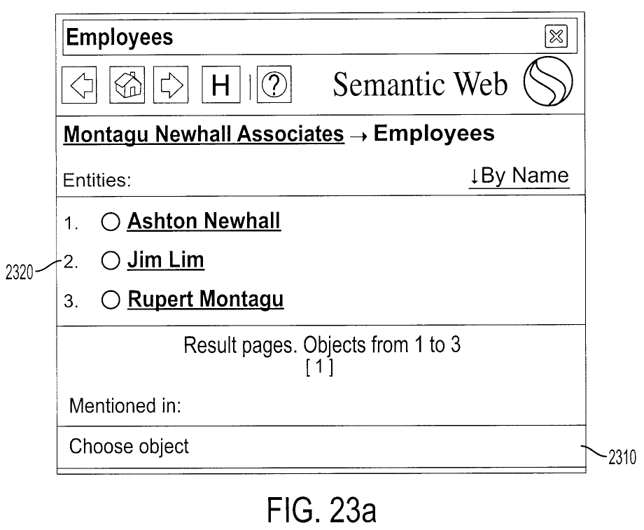

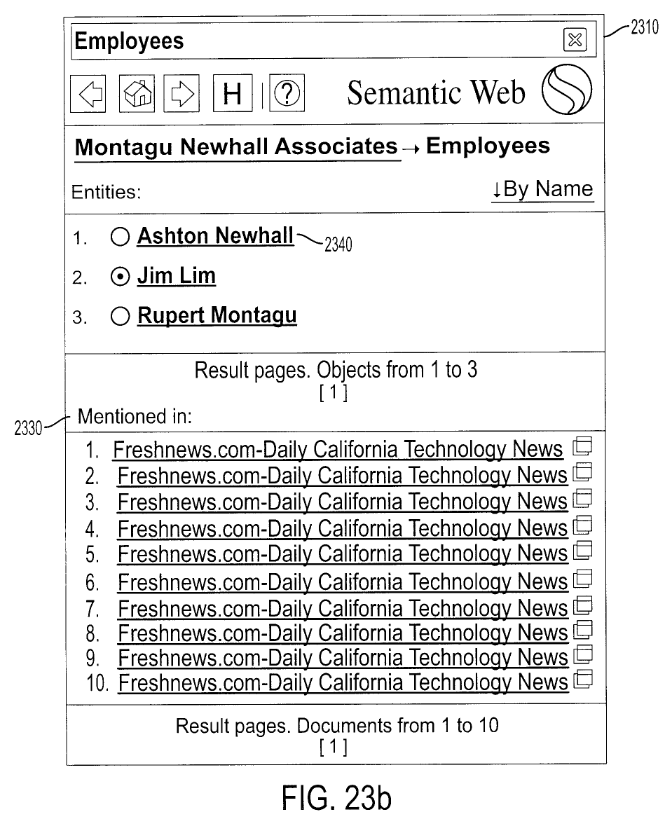

Referring to FIG. 22a, within Navigation Card “Employment” 2210 a user can check radio button 2220 related to one of the objects (e.g. “Montagu Newhall Associates”) connected with current object (e.g. “Rupert Montagu”) by current relation (e.g. “Employment”) to visualize related to this object references 2230 presented in FIG. 22b, choose one of the related reference to open linked Web page in new/same browser window, click on object instance (e.g. “Montagu Newhall Associates” 2240), and, as a result, open Navigation Card related to inverse relation “Employees” for object “Montagu Newhall Associates” (e.g. Navigation Card “Employees” 2310) shown in FIG. 23. After this action requested Relation Navigation Card will be presented to a user and semantic navigation plug-in 202 returns to State-3 of navigation scenario shown in FIG. 18.

FIG. 23a, 23b demonstrate screenshots of Navigation Card for inverse relation “Employees” for object “Montagu Newhall Associates”.

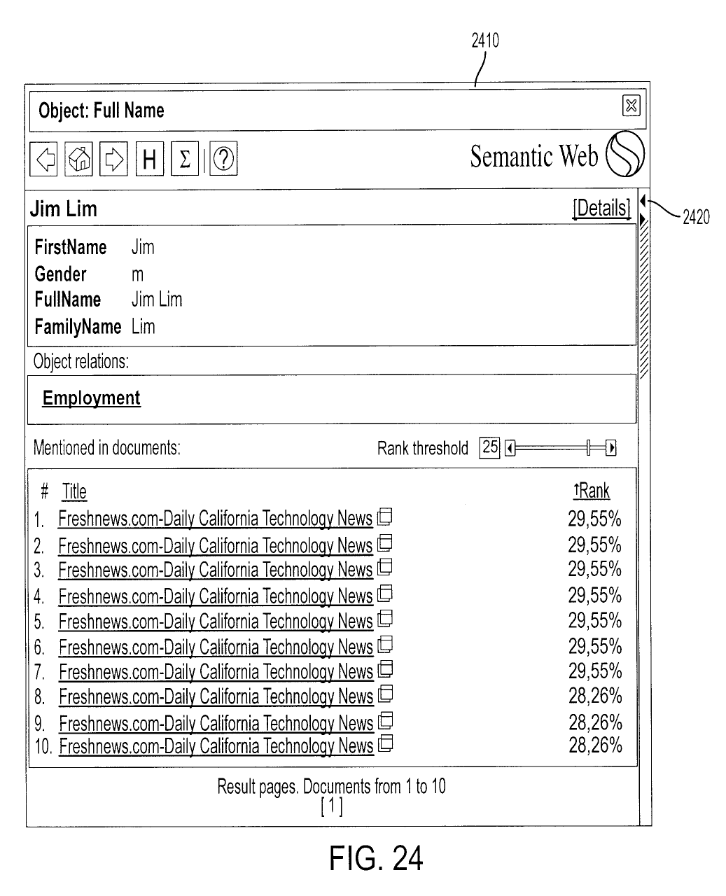

Referring to FIG. 23a, within Navigation Card “Employees” 2310 a user can check radio button 2320 related to one of the objects (for example, “Jim Lim”) connected with current object (e.g. “Montagu Newhall Associates”) by current relation (e.g. “Employees”) to visualize related to this object references 2330 presented in FIG. 23b, choose one of the related reference to open linked Web page in new/same browser window, click on object instance (e.g. “Jim Lim” 2340), and, as a result, open Navigation Card related to object “Jim Lim” (e.g. Navigation Card “Person:Jim Lim” 2410) shown in FIG. 24. After this action requested Relation Navigation Card will be presented to a user and semantic navigation plug-in 202 switches into State-2 of navigation scenario shown in FIG. 18.

FIG. 24 demonstrates screenshot of Navigation Card “Person:Jim Lim”.

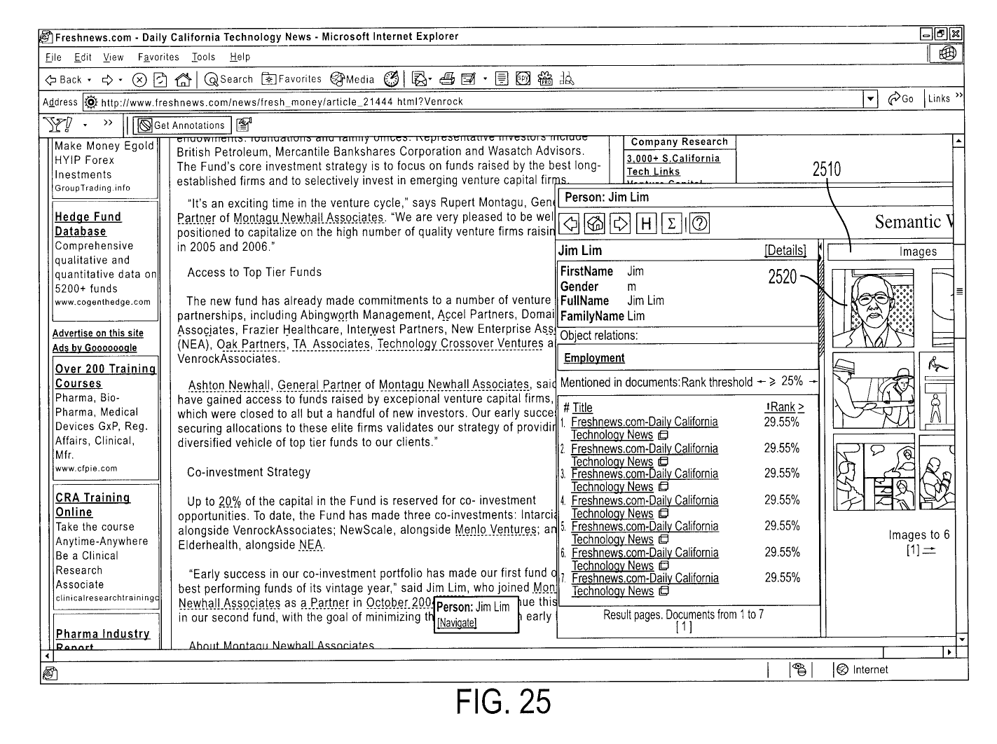

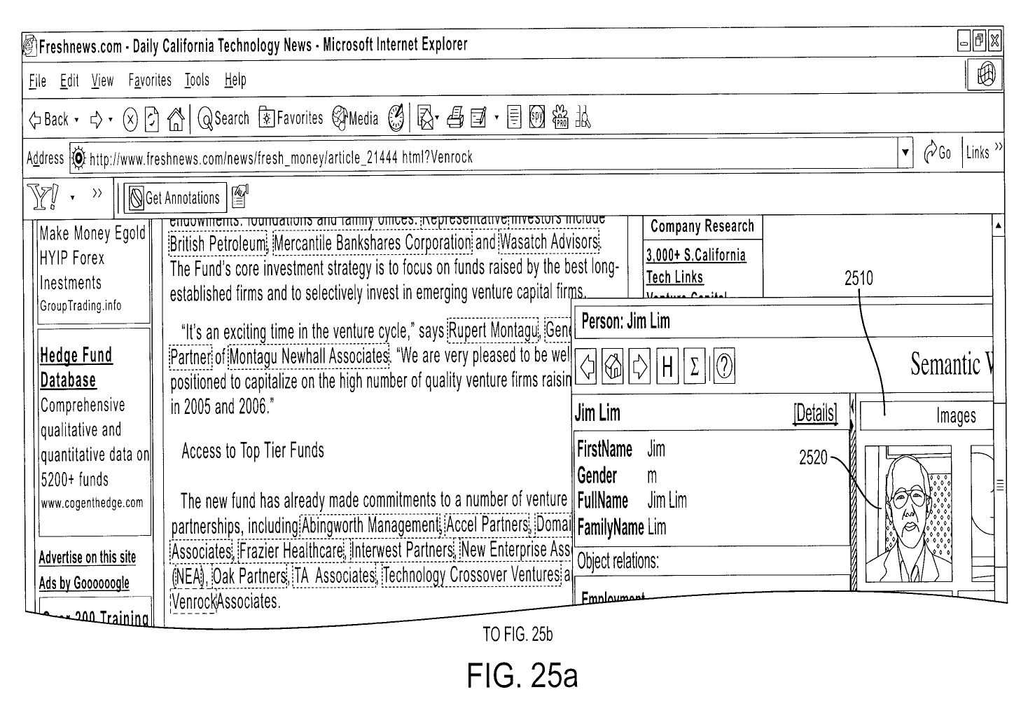

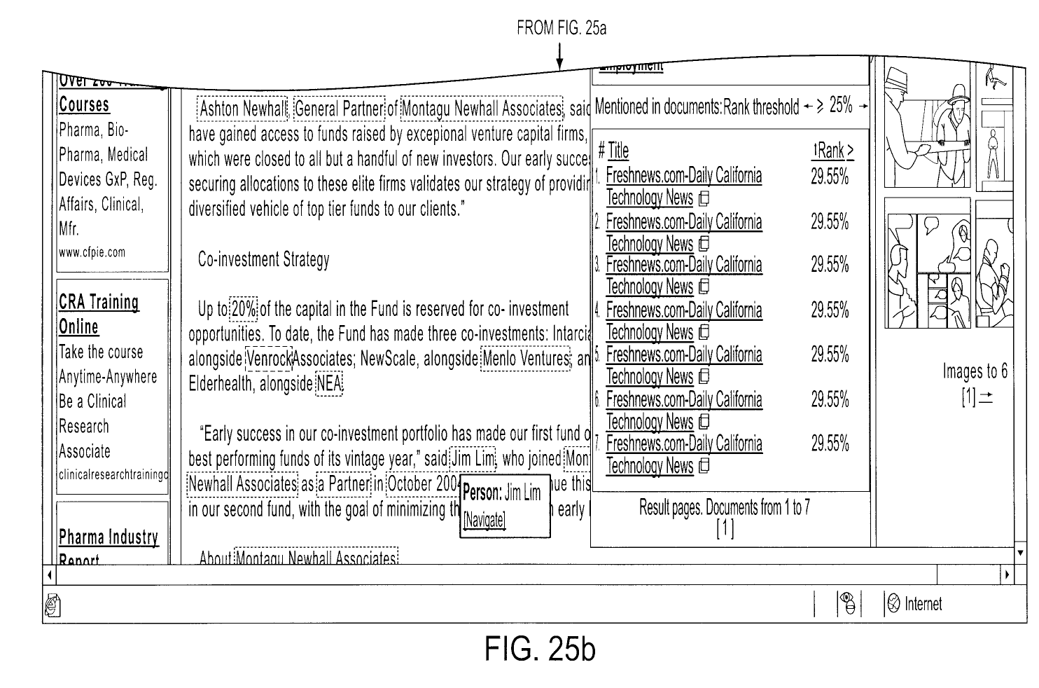

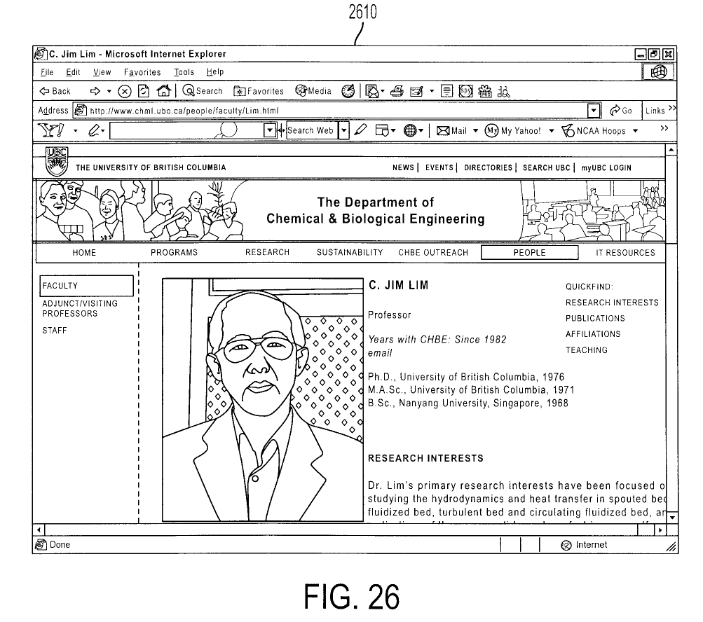

Referring to FIG. 24, Navigation Card “Person:Jim Lim” 2410 is fully equivalent by its structure and functionality to Navigation Card “Person:Rupert Montagu” 2110 shown in FIG. 21. In addition to above discussed options, a user can receive images related to current object with click additional panel 2420. The results of this click presented in FIG. 25.

FIG. 25 demonstrates screenshot of Navigation Card “Person:Jim Lim” with panel of images related to person “Jim Lim”.

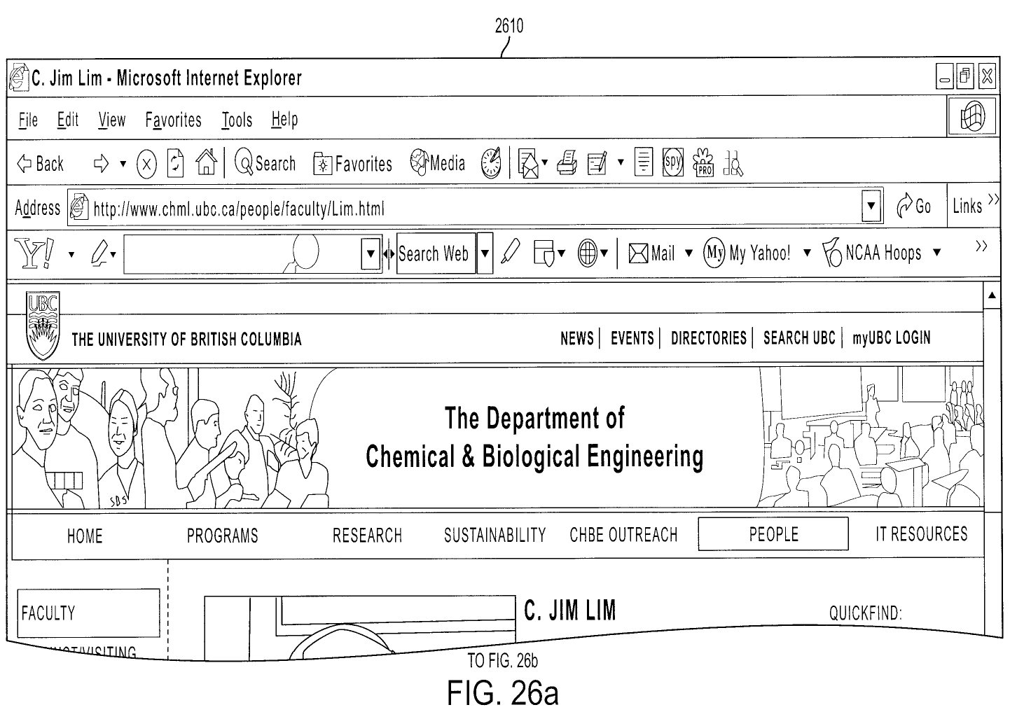

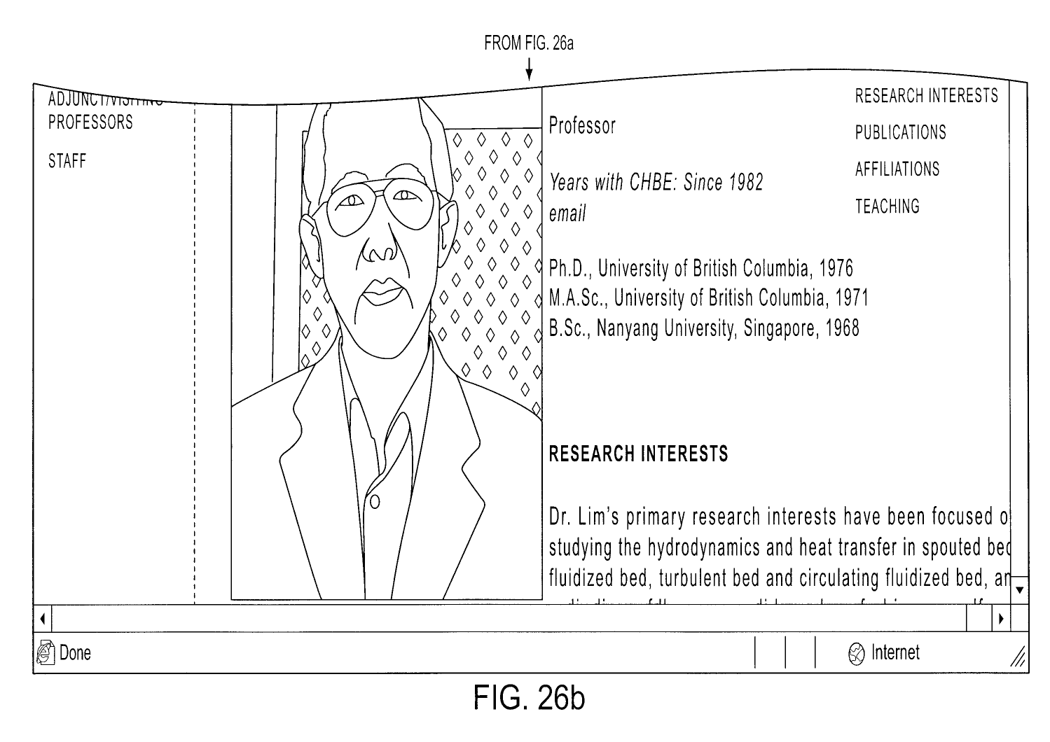

Referring to FIG. 25, Images Panel 2510 within Navigation Card “Person:Jim Lim” represents clickable images related to person “Jim Lim”. For example, click on image 2520 brings to a user in a new Web browser window Professor Jim Lim Home Page presented in FIG. 26.

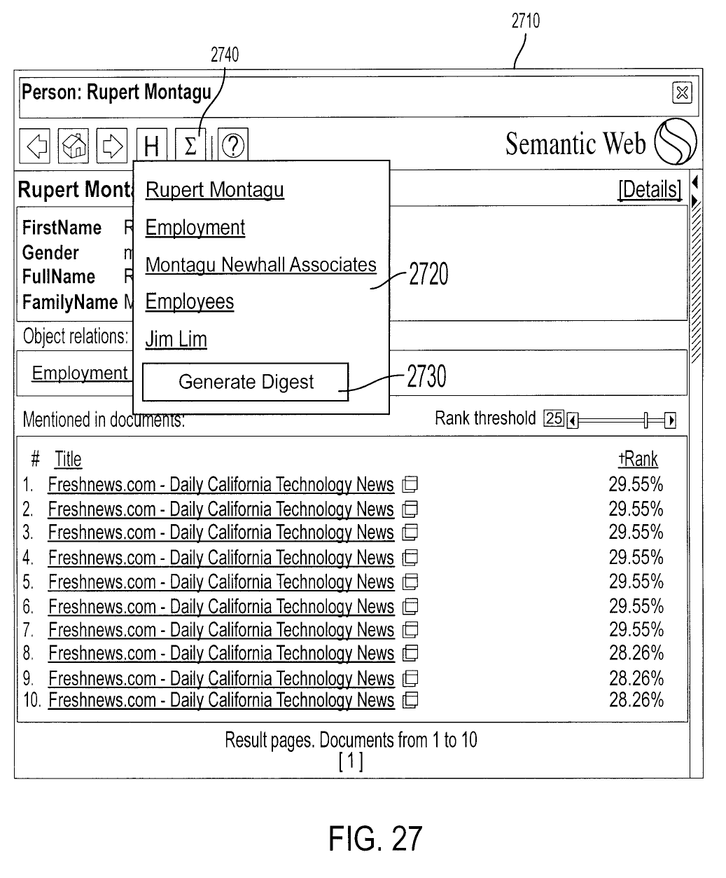

FIG. 27 demonstrates screenshot of Navigation Card “Person:Rupert Montagu” with activated History option.

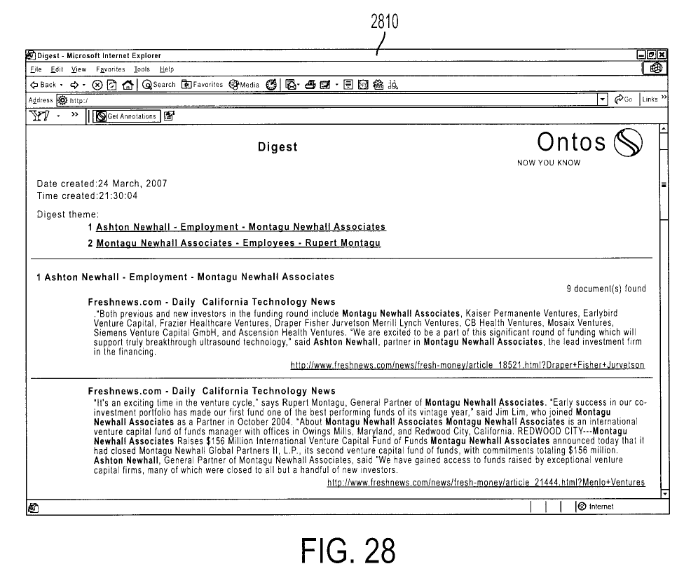

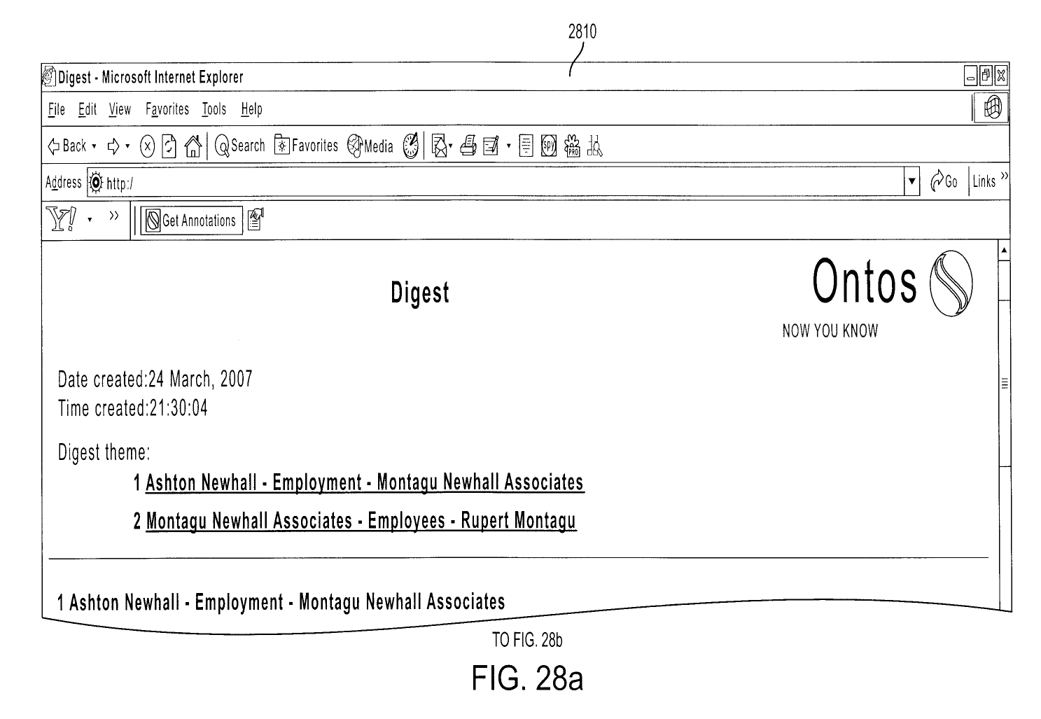

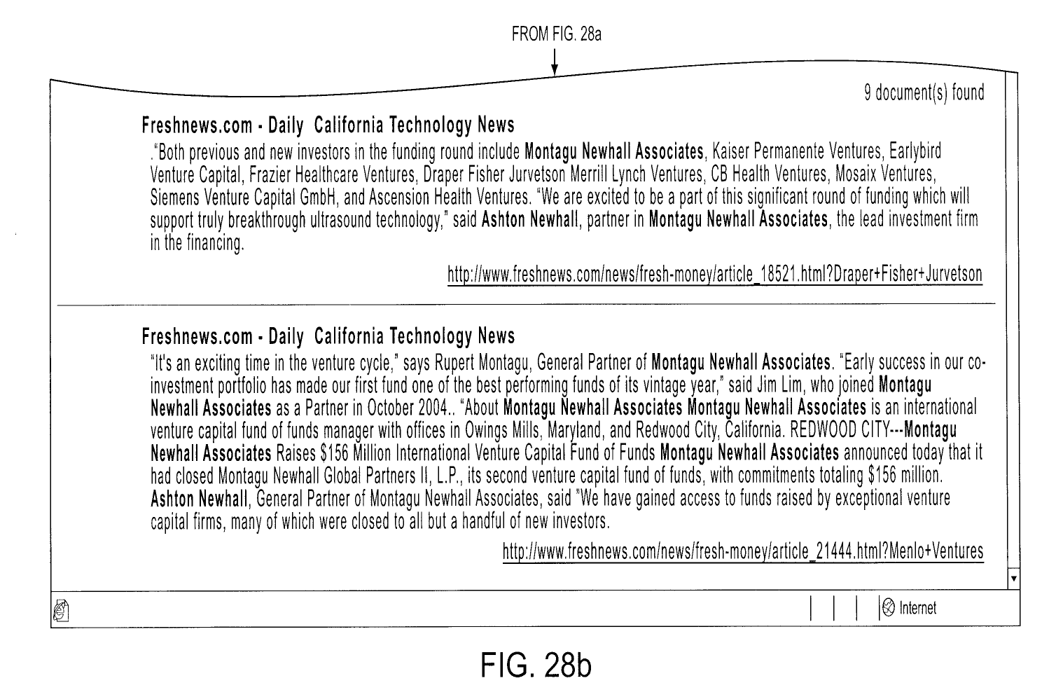

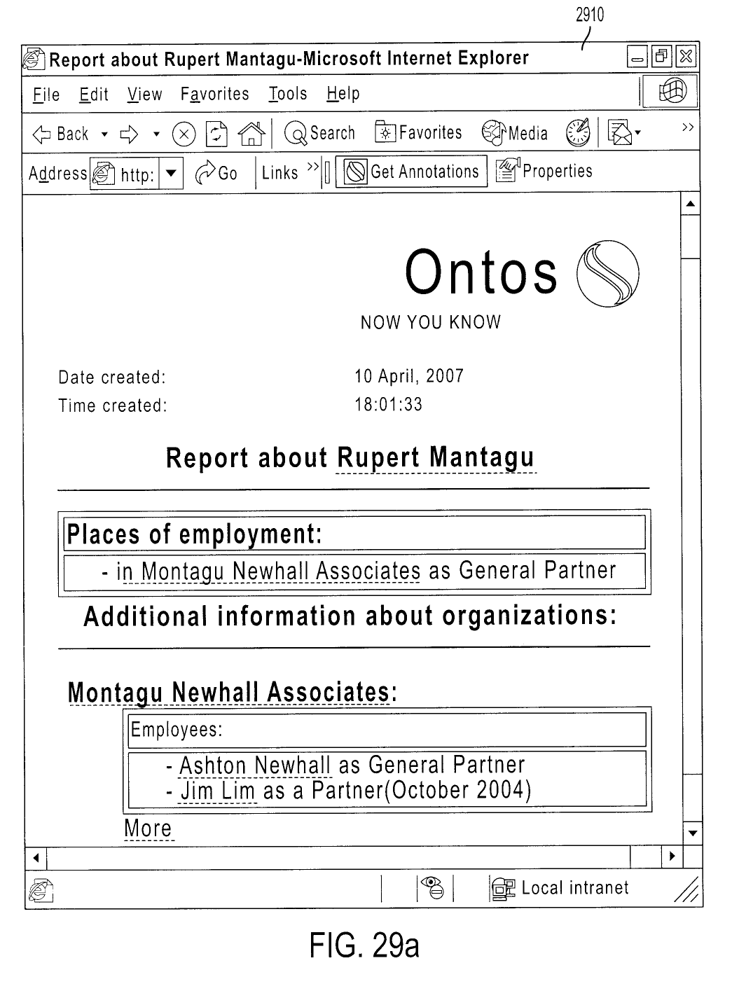

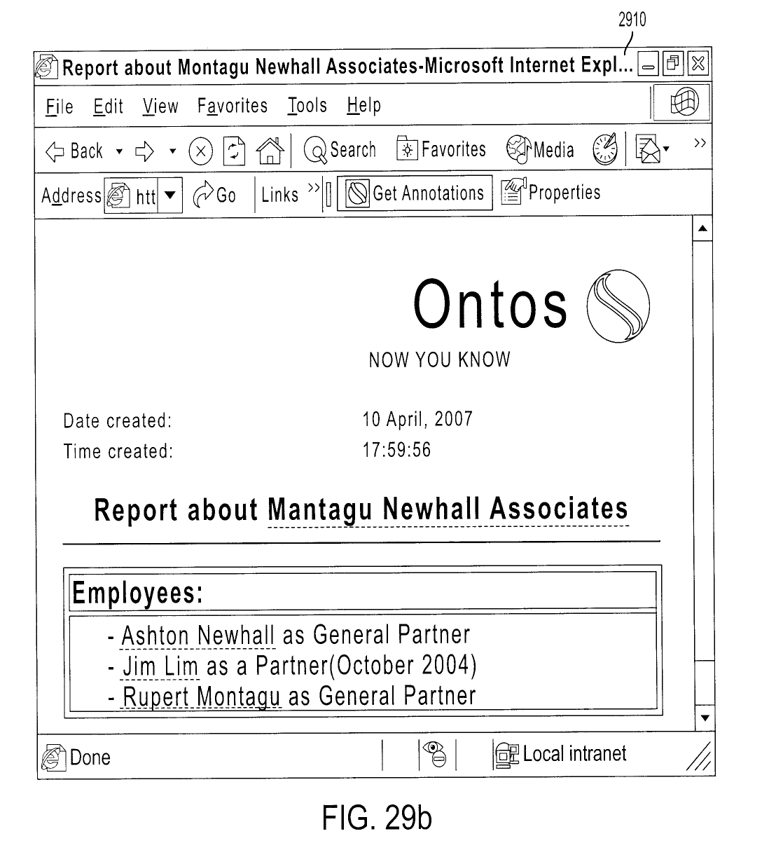

Referring to FIG. 27, Navigation Card “Person:Rupert Montagu” 2710 with activated History option 2720 allows to a user to create semantic digest related to navigation path by pressing the button 2730 “Generate Digest”. As a result of this activity semantic digest for objects and relations presented in navigation history created on the basis of information extracted from related texts will be generated and presented to a user in new Web browser window 2810 shown in FIG. 28. With pressing the button 2740 in Navigation Card “Person:Rupert Montagu” 2710 a user can receive summary 2910 created on the basis of information extracted from related texts about current object presented in FIG. 29a, and pressing the same button in Navigation Card “Organization:Montagu Newhall Associates” a user can receive summary 2910 created on the basis of information extracted from related texts about current object presented in FIG. 29b.

So, according to navigation scenario presented in FIG. 18, a user can fulfill semantic navigation through previously processed by a server system 100 Web pages and/or text documents that is supported by a client system 200 linked with a server system 100 via network 300 provided to he(she) additional significant advantages in comparison with traditional navigation supported by Web browsers.

The invention can be implemented in digital electronic circuitry, or in a computer hardware, firmware, software, or in combinations of the above. The invention can be implemented as a computer program product, i.e. a computer program tangibly embodied in an information carrier, e.g. in a machine readable storage device or in a propagated signal for execution by, or to control the operation of, data processing apparatus, e.g. a programmable processor, a computer, or multiple computers. A computer program can be written in any form of programming language, including compiled or interpreted languages, and it can be deployed in any form, including as a stand-alone program, or as a module, component, subroutine or other unit suitable for use in a computing environment. A computer program can be deployed for execution on one computer or on multiple computers at one site or distributed across multiple sites interconnected by a communication network.

Method steps of the present invention can be performed by, one or multiple programmable processors executing a computer program to perform functions of the present invention by operating on input data and generating output. Method steps of the present invention can also be performed by, and apparatus of the invention can be implemented as, special purpose logic circuitry, e.g. an Field Programmable Gate Array (FPSA) or an Application Specific Integrated Circuit (ASIC).

Processors suitable for the execution of a computer program include, for example, both general and special purpose microprocessors, and any one or more processors of any kind of digital computer. In general, a processor will receive instructions and data from a read-only or a random-access memory or both. The essential elements of a computer are a processor to execute instructions and one or more memory devices to store instructions and data; one or more mass storage devices, e.g. magnetic, magneto-optical, or optical disks; carrier waves. Information carriers suitable for embodying computer program instructions and data include all types of non-volatile memory including, for example, flash memory devices; internal magnetic hard disks or removable disks; magneto-optical disks; CD-ROM and DVD-ROM disks. The processor and the memory can be incorporated in, or supplemented by special purpose logic circuitry.

The invention further comprises the following embodiments:

A method and apparatus for semantic navigation through Web content and collections of documents, comprising:

semantic markup of Web pages and/or documents according to predetermined model of domain presented in the form of domain ontology and representation of markup results in OWL format to store in RDF storage;

storing of results and their links in RDF storage;

semantic navigation across marked up Web pages and/or documents based on the usage of Navigation Cards;

generating of semantic Digests and Summaries related to a user request.

In a further aspect of the invention, semantic markup of Web pages and/or documents according to predetermined model of domain presented in the form of domain ontology, comprise:

markup Web pages and/or documents written in natural language by human experts to extract Named Entities and Relations between them according to predetermined model of domain presented in the form of domain ontology;

markup Web pages and/or documents written in natural language within the automatic information extraction fulfilled according to the method fixed in Russian Patent No 2242048, filed on Feb. 18, 2003, in the Russian Federal Service for Intellectual Property, Patents and Trademarks (ROSPATENT);

merging the same and/or similar Named Entities and Relations extracted from a processed Web page or document, and

representation of results in OWL format to store in RDF storage.

In a further aspect of the invention, storing of results and their links in RDF storage, comprise:

merging Named Entities and Relations extracted from a processed Web page or document and the same and/or similar Named Entities and Relations already stored in RDF storage, and storing of results and their links in RDF storage as a set of triples.

In a further aspect of the invention, semantic navigation across marked up Web pages and/or documents based on the usage of Navigation Cards, further comprise:

displaying queried by a user Web page or document in Web browser;

highlighting of Named Entities and Relations presented in displayed Web page or document;

presenting to a user according his(her) request Object Navigation Card for chosen within displayed Web page or document Named Entity;

displaying in Object Navigation Card for chosen Named Entity its attributes with their values, connected Relations, and ranked list of references at documents where chosen Named Entity was mentioned;

presenting to a user according his(her) request Relation Navigation Card for chosen from Object Navigation Card semantic relation connected with current Named Entity;

displaying in Relation Navigation Card Named Entities connected with chosen Named Entity by chosen Relation, and ranked list of references at documents where chosen triple Named Entity-Relation-Named Entity was mentioned;

presenting to a user according his(her) request next Relation Navigation Card if chosen in previous Relation Navigation Card Named Entity has semantic relation inverse to depicted in previous Relation Navigation Card relation, and Object Navigation Card for chosen Named Entity, otherwise, and

saving a user navigation history within Object Navigation Card and Relation Navigation Card.

In a further aspect of the invention, generating of semantic Digest and Summary related to a user request, further comprise:

presenting to a user according his(her) request a possibility to create semantic Digest related to the navigation path;

visualization in Web browser window semantic Digest generated according to a user request;

presenting to a user according his(her) request a possibility to create a summary based on the information extracted from all related Web pages and/or documents about Named Entity interested in, and

visualization in Web browser window a summary generated according to a user request.

In a further aspect of the invention, displaying comprises a Web browser.

In a further aspect of the invention, the Web browser comprises a semantic navigation plug-in.

In a further aspect of the invention, the Web browser loads a Web page or document according a user request.

In a further aspect of the invention, the semantic navigation plug-in loads semantic markup related to loaded Web page or document.

In a further aspect of the invention, the semantic navigation plug-in highlights Named Entities and Relations presented in displayed Web page or document with color.

In a further aspect of the invention, the semantic navigation plug-in presents to a user according his(her) request Object Navigation Card for chosen within displayed Web page or document Named Entity.

In a further aspect of the invention, the semantic navigation plug-in displays in Object Navigation Card for chosen Named Entity its attributes with their values, connected Relations, and ranked list of references at documents where chosen Named Entity was mentioned.

In a further aspect of the invention, the semantic navigation plug-in presents to a user according his(her) request Relation Navigation Card for chosen from Object Navigation Card semantic relation connected with current Named Entity.

In a further aspect of the invention, the semantic navigation plug-in displays in Relation Navigation Card Named Entities connected with chosen Named Entity by chosen Relation, and ranked list of references at documents where chosen triple Named Entity-Relation-Named Entity was mentioned.

In a further aspect of the invention, wherein the semantic navigation plug-in presents to a user according his(her) request next Relation Navigation Card if chosen in previous Relation Navigation Card Named Entity has semantic relation inverse to depicted in previous Relation Navigation Card relation, and Object Navigation Card for chosen Named Entity, otherwise.

In a further aspect of the invention, the semantic navigation plug-in saves a user navigation history within Object Navigation Card and Relation Navigation Card.

In a further aspect of the invention, the semantic navigation plug-in presents to a user according his(her) request a possibility to create semantic Digest related to the navigation path.

In a further aspect of the invention, the semantic navigation plug-in visualizes in Web browser window semantic Digest generated according to a user request.

In a further aspect of the invention, the semantic navigation plug-in presents to a user according his(her) request a possibility to create a summary based on the information extracted from all related Web pages and/or documents about Named Entity interested in.

In a further aspect of the invention, the semantic navigation plug-in visualizes in Web browser window a summary generated according to a user request.

The invention further comprises a computer program product, tangibly embodied in an information carrier, for semantic navigation in a network of interconnected computer systems, the computer program product being operable to cause data processing apparatus to:

markup of Web pages and/or documents according to predetermined model of domain presented in the form of domain ontology and to represent markup results in OWL format to store in RDF storage;

store results and their links represented as Universal Resource Locators (URLs) in RDF storage;

navigate across marked up Web pages and/or documents based on the usage of Navigation Cards;

generate of semantic Digests and Summaries.

In a further aspect of the invention, semantic markup of Web pages and/or documents written in natural language fulfilled manually by human experts who extract Named Entities and Relations between them according to predetermined model of domain presented in the form of domain ontology and represent the results in OWL format or fulfilled automatically by information extraction system implemented according to the method fixed in Russian Patent No 2242048, filed on Feb. 18, 2003, in the Russian Federal Service for Intellectual Property, Patents and Trademarks (ROSPATENT) that represents the results in OWL format; and merging of the same and/or similar Named Entities and Relations extracted from a processed Web page or document implemented according to the inventive method.

In a further aspect of the invention, storing of results and their links in RDF storage fulfilled by merging Named Entities and Relations extracted from a processed Web page or document and the same and/or similar Named Entities and Relations already stored in RDF storage, and saving results with their URLs in RDF storage as a set of triples implemented according to the inventive method.

In a further aspect of the invention, semantic navigation across marked up Web pages and/or documents implemented to display queried by a user Web page or document in Web browser; highlight of Named Entities and Relations presented in displayed Web page or document with a color; present to a user according his(her) request Object Navigation Card for chosen within displayed Web page or document Named Entity; display in Object Navigation Card for chosen Named Entity its attributes with their values, connected Relations, and ranked list of references at documents where chosen Named Entity was mentioned; present to a user according his(her) request Relation Navigation Card for chosen from Object Navigation Card semantic relation connected with current Named Entity; display in Relation Navigation Card Named Entities connected with chosen Named Entity by chosen Relation, and ranked list of references at documents where chosen triple Named Entity-Relation-Named Entity was mentioned; present to a user according his(her) request next Relation Navigation Card if chosen in previous Relation Navigation Card Named Entity has semantic relation inverse to depicted in previous Relation Navigation Card relation, and Object Navigation Card for chosen Named Entity, otherwise; and save a user navigation history within Object Navigation Card and Relation Navigation Card.

In a further aspect of the invention, generating of semantic Digest and Summary related to a user request implemented to present to a user according his(her) request a possibility to create semantic Digest related to the navigation path; visualize in Web browser window semantic Digest generated according to a user request; present to a user according his(her) request a possibility to create a summary based on the information extracted from all related Web pages and/or documents about Named Entity interested in; and visualize in Web browser window a summary generated according to a user request.

In a further aspect of the invention, displaying comprises a Web browser.

In a further aspect of the invention, the Web browser comprises a semantic navigation plug-in.

In a further aspect of the invention, the Web browser loads a Web page or document according a user request.

In a further aspect of the invention, the semantic navigation plug-in loads semantic markup related to loaded Web page or document.

In a further aspect of the invention, the semantic navigation plug-in highlights Named Entities and Relations presented in displayed Web page or document with color.

In a further aspect of the invention, the semantic navigation plug-in presents to a user according his(her) request Object Navigation Card for chosen within displayed Web page or document Named Entity.

In a further aspect of the invention, the semantic navigation plug-in displays in Object Navigation Card for chosen Named Entity its attributes with their values, connected Relations, and ranked list of references at documents where chosen Named Entity was mentioned.

In a further aspect of the invention, the semantic navigation plug-in presents to a user according his(her) request Relation Navigation Card for chosen from Object Navigation Card semantic relation connected with current Named Entity.

In a further aspect of the invention, the semantic navigation plug-in displays in Relation Navigation Card Named Entities connected with chosen Named Entity by chosen Relation, and ranked list of references at documents where chosen triple Named Entity-Relation-Named Entity was mentioned.

In a further aspect of the invention, the semantic navigation plug-in presents to a user according his(her) request next Relation Navigation Card if chosen in previous Relation Navigation Card Named Entity has semantic relation inverse to depicted in previous Relation Navigation Card relation, and Object Navigation Card for chosen Named Entity, otherwise.

In a further aspect of the invention, the semantic navigation plug-in saves a user navigation history within Object Navigation Card and Relation Navigation Card.

In a further aspect of the invention, the semantic navigation plug-in presents to a user according his(her) request a possibility to create semantic Digest related to the navigation path.

In a further aspect of the invention, the semantic navigation plug-in visualizes in Web browser window semantic Digest generated according to a user request.

In a further aspect of the invention, the semantic navigation plug-in presents to a user according his(her) request a possibility to create a summary based on the information extracted from all related Web pages and/or documents about Named Entity interested in.

In a further aspect of the invention, the semantic navigation plug-in visualizes in Web browser window a summary generated according to a user request.

The invention further comprises a system for semantic navigation through Web content and collections of documents, comprising:

in a network of interconnected computer systems, means for semantic markup of Web pages and/or documents according to predetermined model of domain presented in the form of domain ontology and representation of markup results in OWL format to store in RDF storage;

means for storing of results and their links in RDF storage;

means for semantic navigation across marked up Web pages and/or documents based on the usage of Navigation Cards;

means for generating of semantic Digests and Summaries related to a user request.

In a further aspect of the invention, semantic markup of Web pages and/or documents according to predetermined model of domain presented in the form of domain ontology, comprises:

means for markup Web pages and/or documents written in natural language by human experts manually to extract Named Entities and Relations between them according to predetermined model of domain presented in the form of domain ontology;

means for markup Web pages and/or documents written in natural language within the automatic information extraction fulfilled according to the method fixed in Russian Patent No 2242048, filed on Feb. 18, 2003, in the Russian Federal Service for Intellectual Property, Patents and Trademarks (ROSPATENT);

means for merging the same and/or similar Named Entities and Relations extracted from a processed Web page or document, and

means for representation of results in OWL format to store in RDF storage.

In a further aspect of the invention, storing of results and their links in RDF storage, comprises:

means for merging Named Entities and Relations extracted from a processed Web page or document and the same and/or similar Named Entities and Relations already stored in RDF storage, and means for storing of results and their links in RDF storage as a set of triples.

In a further aspect of the invention, semantic navigation across marked up Web pages and/or documents based on the usage of Navigation Cards, further comprises:

means for displaying queried by a user Web page or document in Web browser;

means for highlighting of Named Entities and Relations presented in displayed Web page or document;

means for presenting to a user according his(her) request Object Navigation Card for chosen within displayed Web page or document Named Entity;

means for displaying in Object Navigation Card for chosen Named Entity its attributes with their values, connected Relations, and ranked list of references at documents where chosen Named Entity was mentioned;

means for presenting to a user according his(her) request Relation Navigation Card for chosen from Object Navigation Card semantic relation connected with current Named Entity;

means for displaying in Relation Navigation Card Named Entities connected with chosen Named Entity by chosen Relation, and ranked list of references at documents where chosen triple Named Entity-Relation-Named Entity was mentioned;

means for presenting to a user according his(her) request next Relation Navigation Card if chosen in previous Relation Navigation Card Named Entity has semantic relation inverse to depicted in previous Relation Navigation Card relation, and Object Navigation Card for chosen Named Entity, otherwise, and

means for saving a user navigation history within Object Navigation Card and Relation Navigation Card.

In a further aspect of the invention, generating of semantic Digests and Summaries related to a user request, further comprises:

means for presenting to a user according his(her) request a possibility to create semantic Digest related to the navigation path;

means for visualization in Web browser window semantic Digest generated according to a user request;

means for presenting to a user according his(her) request a possibility to create a summary based on the information extracted from all related Web pages and/or documents about Named Entity interested in, and

means for visualization in Web browser window a summary generated according to a user request.

In a further aspect of the invention, means for displaying comprises a Web browser.

In a further aspect of the invention, the Web browser comprises a semantic navigation plug-in.

In a further aspect of the invention, the Web browser loads a Web page or document according a user request.

In a further aspect of the invention, the semantic navigation plug-in loads semantic markup related to loaded Web page or document.

In a further aspect of the invention, the semantic navigation plug-in means for highlighting Named Entities and Relations presented in displayed Web page or document with color.

In a further aspect of the invention, the semantic navigation plug-in means for representing to a user according his(her) request Object Navigation Card for chosen within displayed Web page or document Named Entity.

In a further aspect of the invention, the semantic navigation plug-in means for displaying in Object Navigation Card for chosen Named Entity its attributes with their values, connected Relations, and ranked list of references at documents where chosen Named Entity was mentioned.

In a further aspect of the invention, the semantic navigation plug-in means for representing to a user according his(her) request Relation Navigation Card for chosen from Object Navigation Card semantic relation connected with current Named Entity.

In a further aspect of the invention, the semantic navigation plug-in means for displaying in Relation Navigation Card Named Entities connected with chosen Named Entity by chosen Relation, and ranked list of references at documents where chosen triple Named Entity-Relation-Named Entity was mentioned.

In a further aspect of the invention, the semantic navigation plug-in means for representing to a user according his(her) request next Relation Navigation Card if chosen in previous Relation Navigation Card Named Entity has semantic relation inverse to depicted in previous Relation Navigation Card relation, and Object Navigation Card for chosen Named Entity, otherwise.

In a further aspect of the invention, the semantic navigation plug-in means for saving a user navigation history within Object Navigation Card and Relation Navigation Card.

In a further aspect of the invention, the semantic navigation plug-in means for representing to a user according his(her) request a possibility to create semantic Digest related to the navigation path.

In a further aspect of the invention, the semantic navigation plug-in means for visualizing in Web browser window semantic Digest generated according to a user request.

In a further aspect of the invention, the semantic navigation plug-in means for presenting to a user according his(her) request a possibility to create a summary based on the information extracted from all related Web pages and/or documents about Named Entity interested in.

In a further aspect of the invention, the semantic navigation plug-in means for visualizing in Web browser window a summary generated according to a user request.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation.

1. A method for navigating through a plurality of electronic documents, the method comprising:
semantic marking-up electronic documents according to a predetermined domain model presented in the form of domain ontology, thereby creating mark-up results represented in ontology web language; and
storing the mark-up results and the links to the marked-up electronic documents represented by universal resource locators in a resource description framework storage.

2. The method of claim 1, wherein semantic marking up of electronic documents comprises at least one of:
manually marking up electronic documents written in natural language by extracting named entities and relations between the named entities according to the predetermined domain model presented in the form of domain ontology; and
marking up electronic documents written in natural language by an automatic information extraction method; and
merging same and/or similar named entities and relations extracted from a processed electronic document.

3. The method of claim 1, wherein storing of mark-up results and the links in resources description framework (RDF) storage further comprises:
merging named entities and relations extracted from a processed electronic document and same and/or similar named entities and relations already stored in RDF storage; and
storing the mark-up results with their universal resource locators in RDF storage as a set of triples.

4. A method for navigating through a plurality of electronic documents, the method comprising:
semantic navigating across marked-up electronic documents using navigation cards; and
generating semantic digests and semantic summaries of electronic documents upon a user request.

5. The method of claim 4, wherein semantic navigation across marked up electronic documents further comprises:
displaying, queried by a user, at least one electronic document in a Web browser;
highlighting of named entities and relations between the named entities within the at least one displayed electronic document;
presenting to a user upon request an object navigation card for selecting at least one named entity within the displayed electronic document;
displaying on the object navigation card
selectable named entities,
the attributes of the named entities and the values of the attributes,
connected relations between the named entities, and
a ranked list of references to electronic documents which contain a selected named entity;
presenting to a user upon request a first relation navigation card for selecting a semantic relation connected with the selected named entity from the object navigation card;
displaying on the first relation navigation card
named entities connected with the selected named entity by the selected semantic relation, and
a ranked list of references to electronic documents which contain the selected triple (named entity; relation; named entity);
presenting to a user upon request
a second relation navigation card if the selected named entity on the first relation navigation card has a semantic relation inverse to the displayed semantic relation on the first navigation card, and
an object navigation card for the selected named entity, otherwise; and
saving a user navigation history within object navigation card and relation navigation card.

6. The method of claim 4, wherein generating semantic digests and semantic summaries upon a user request further comprises;
presenting to a user upon request a possibility to create semantic digests related to the navigation path;
displaying the semantic digests created upon request;
presenting to a user upon request a possibility to create a semantic summary based on the information extracted from all related electronic documents which contain a selected named entity; and
displaying the semantic summary created upon request.

7. The method of claim 4, wherein displaying comprises displaying in a Web browser.

8. The method of claim 7, wherein the Web browser comprises a semantic navigation plug-in.

9. The method of claim 7, wherein the Web browser loads an electronic document upon user request.

10. The method of claim 8, wherein the semantic navigation plug-in causes loading semantic mark-up data related to a loaded electronic document.

11. The method of claim 8, wherein the semantic navigation plug-in causes highlighting, the named entities and semantic relations within the displayed electronic document.

12. The method of claim 8, wherein the semantic navigation plug-in causes presenting to a user upon request an object navigation card for selecting a named entity within the displayed electronic document.

13. The method of claim 8, wherein the semantic navigation plug-in causes displaying on the object navigation card
the attributes for the selected named entity and the values for the attributes,
the connected semantic relations, and
a ranked list of references to documents which contain the selected named entity.

14. The method of claim 8, wherein the semantic navigation plug-in causes presenting to a user upon request a first relation navigation card for selecting semantic relations connected with the selected named entity from the object navigation card.

15. The method of claim 8, wherein the semantic navigation plug-in displays on the first relation navigation card:
named entities connected with the selected Named entity by the selected semantic relation, and
a ranked list of references to electronic documents which contain the triple (named entity; relation; named entity).

16. The method of claim 8, wherein the semantic navigation plug-in presents to a user upon request
a second relation navigation card if the selected named entity on the first relation navigation card has a semantic relation inverse to the displayed semantic relation on the first relation navigation card, and
an object navigation card for the selected named entity, otherwise.

17. The method of claim 8, wherein the semantic navigation plug-in causes saving a user navigation history within object navigation card and relation navigation card.

18. The method of claim 8, wherein the semantic navigation plug-in causes presenting to a user upon request a possibility to create semantic digests related to the navigation path.

19. The method of claim 8, wherein the semantic navigation plug-in causes displaying the semantic digests generated upon user request.

20. The method of claim 8, wherein the semantic navigation plug-in causes presenting to a user upon request a possibility to create a semantic summary based on the information extracted from all related electronic documents which contain a selected named entity.

21. The method of claim 8, wherein the semantic navigation plug-in causes displaying the semantic summary generated upon user request.

22.-66. (canceled)
